(19) United States
(12) Patent Application Publication
(10) Pub. No.: US 2020/0024535 A1
(43) Pub. Date: Jan. 23, 2020

(54) SYSTEMS AND METHODS FOR COLLECTING, TRANSPORTING AND REPURPOSING OR DESTROYING UNUSED PHARMACEUTICALS

(71) Applicant: SHARPS COMPLIANCE, INC. OF TEXAS, Houston, TX (US)

(72) Inventors: David P. Tusa, Houston, TX (US); Khairan Aladwani, Houston, TX (US); Greg C. Davis, Houston, TX (US); Jan Harris, Houston, TX (US)

(21) Appl. No.: 16/536,747

(22) Filed: Aug. 9, 2019

Related U.S. Application Data
(63) Continuation of application No. 14/533,381, filed on Nov. 5, 2014.
Application No. 14/533,381 is a continuation-in-part of application No. 13/608,110, filed on Sep. 10, 2012, now abandoned.
Application No. 13/608,110 is a continuation-in-part of application No. 13/454,920, filed on Apr. 24, 2012, now abandoned.
Application No. 13/454,920 is a continuation-in-part of application No. 12/713,733, filed on Feb. 26, 2010, now abandoned.
(60) Provisional application No. 61/900,034, filed on Nov. 5, 2013.

(51) Int. Cl. C10L 5/48; F23G 5/033; C10L 5/46; F23G 5/44; C10L 5/36; F23G 5/04; F23G 5/02

(52) U.S. Cl. CPC C10L 5/48; C10L 2200/0461; C10L 5/46; F23G 5/448; C10L 5/36; F23G 5/04; F23G 5/02; F23G 2900/50206; F23G 2209/26; F23G 2209/20; F23K 2201/501; Y02E 50/30; F23G 2201/70; F23G 2209/28; Y02E 50/10; C10L 2290/02; C10L 2290/567; F23G 5/033

(57) ABSTRACT

Systems and methods implementing the systems including a facility including a plurality of collection apparatuses distributed in the facility for ease of collection and transportation. The system also includes transportation subsystems for shipping filled inner containers to a processing subsystem and for transporting a fuel material or a land fillable material to incineration or landfill subsystems. The systems may also include a monitoring subsystem for monitoring the deployed collection apparatuses, inner containers, the fuel material and the land fillable material.

### RELATED APPLICATIONS

This application is a continuation application which claims priority from U.S. utility application Ser. No. 14/533,381, filed Nov. 5, 2014, that claims priority from U.S. provisional application No. 61/900,034, filed Nov. 5, 2013, and is a continuation-in-part of U.S. utility application Ser. No. 13/454,920, filed Apr. 24, 2012, Ser. No. 13/608,110, filed Sep. 10, 2012, and Ser. No. 12/713,733, filed Feb. 26, 2010, each of which is hereby incorporated by reference in its entirety.

### BACKGROUND OF THE INVENTION

### 1. Field of the Invention

Embodiments of this invention relate to secure systems and methods for collecting, transporting, and repurposing and/or destroying used, unused, and/or waste pharmaceutical containing materials including over-the-counter (OTC) pharmaceuticals, prescription pharmaceuticals and controlled pharmaceuticals.

More particularly, embodiments of this invention relate to secure systems and methods for collecting, transporting and re-purposing and/or destroying used, unused, and/or waste pharmaceutical containing materials including over-the-counter (OTC) pharmaceuticals, prescription pharmaceuticals and controlled pharmaceuticals, where the systems and methods including placing secure collection apparatuses in facilities that generate used, unused, and/or waste pharmaceutical materials including over-the-counter (OTC) pharmaceuticals, prescription pharmaceuticals, controlled pharmaceuticals, where the apparatuses include a lockable outer metallic container and a transportable inner container and where the apparatuses, outer container or inner container may include monitoring and tracking hardware and software.

### 2. Description of the Related Art

Currently, the collection and transportation of unused pharmaceuticals including over-the-counter (OTC) pharmaceuticals, prescription pharmaceuticals and controlled pharmaceuticals that are either unused, out of specification or otherwise in need of disposal is a challenging problem especially in senior care, psychical care, hospitals, clinics, extended care, retail pharmacies, or other care or pharmacy facilities that utilize pharmaceuticals including over-the-counter (OTC) pharmaceuticals, prescription pharmaceuticals and controlled pharmaceuticals.

Thus, there is a need in the art for systems and methods for collecting, transporting and re-purposing and/or disposing of unused pharmaceuticals including over-the-counter (OTC) pharmaceuticals, prescription pharmaceuticals and controlled pharmaceuticals.

### SUMMARY OF THE INVENTION

Embodiments of the invention provide systems for deploying, collecting, transporting, and re-purposing or disposing of used, unused, and/or waste pharmaceutical containing materials, where the materials include over-the-counter (OTC) pharmaceuticals, prescription pharmaceuticals and controlled pharmaceuticals. The systems include a deployment subsystem including one receptacle or a plurality of receptacles deployed at a locations or a plurality of locations within one facility or a plurality of facilities that generate used, unused, and/or waste pharmaceutical containing materials in need of being collected and disposed. The systems also include a transportation subsystem comprising a common carrier, a common courier, a contract carrier and/or contract courier for collecting and transporting used, unused, and/or waste pharmaceutical materials. The systems also includes a re-purposing subsystem including pre-treating units, processing units, and/or containerizing units for receiving the transported used, unused, and/or waste pharmaceutical materials to form a re-purposed waste pharmaceutical material. The systems also include a disposal subsystem including a landfill facility, a cement facility, or an industrial facility for receiving and disposing of the re-purposed waste pharmaceutical material.

Embodiments of the invention provide methods for deploying, collecting, transporting, re-purposing, and disposing of used, unused, and/or waste pharmaceutical containing materials. The methods include deploying one receptacle or a plurality of receptacles deployed at a locations or a plurality of locations within one facility or a plurality of facilities that generate used, unused, and/or waste pharmaceutical containing materials. The methods also include collecting and transporting collected used, unused, and/or waste pharmaceutical containing materials. The methods also include re-purposing the used, unused, and/or waste pharmaceutical containing materials to form a re-purposed waste pharmaceutical containing material. The methods also include disposing of re-purposed waste pharmaceutical containing material either via landfilling or burning the re-purposed waste pharmaceutical containing material as a fuel in cement facility, incineration facilities, or other industrial facilities that burn fuels to produce energy or energy and a final product.

### BRIEF DESCRIPTION OF THE DRAWINGS

The invention can be better understood with reference to the following detailed description together with the appended illustrative drawings in which like elements are numbered the same:

FIG. 1A depicts an embodiment of a collection apparatus of this invention.

FIG. 1B depicts another embodiment of a collection apparatus of FIG. 1A.

FIG. 2A depicts another embodiment of a collection apparatus of this invention.

FIG. 2B depicts another embodiment of a collection apparatus of FIG. 2A.

FIG. 3A depicts another embodiment of a collection apparatus of this invention.

FIG. 3B depicts another embodiment of a collection apparatus of FIG. 3A.

FIG. 4A depicts an embodiment of an inner container of this invention.

FIG. 4B depicts another embodiment of an inner container of FIG. 4A.

FIG. 4C depicts another embodiment of an inner container of this invention.

FIG. 4D depicts another embodiment of an inner container of FIG. 4C.

FIG. 5 depicts an embodiment of a system of this invention.

### DEFINITIONS OF TERMS USED IN THE INVENTION

The following definitions are provided in order to aid those skilled in the art in understanding the detailed description of the present invention.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “substantially” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

### Detailed Description of the Invention

The inventors have found that systems and methods may be constructed and implemented for collecting, transporting, re-purposing, and disposing of used, unused, and/or waste pharmaceutical containing materials including over-the-counter (OTC) pharmaceuticals, prescription pharmaceuticals and controlled pharmaceuticals, where the systems include placing one or plurality of receptacles in a facility in need of disposing of used, unused, and/or waste pharmaceutical containing materials, where the receptacles include an outer lockable metallic container, where the outer lockable metallic container includes a unidirectional apparatus supporting deposition of used, unused, and/or waste pharmaceutical containing materials and an inner transportable container. The inventors have also found that the outer containers and the inner containers may include anti-tampering subsystems to guard against external tampering with or removal from the inner container during collection, transportation and re-purposing or disposal of the used, unused, and/or waste pharmaceutical containing materials.

In certain embodiments, the outer container also includes a surveillance subsystem to monitor collection of the used, unused, and/or waste pharmaceutical containing materials in the outer container. In other embodiments, the outer container also includes an anti-tampering subsystem. In other embodiments, the outer container includes a processing subsystem for monitoring the integrity of the outer container and for collecting data associated with the inner container. In other embodiments, the processing subsystem includes communication hardware and software for transmitting outer container data to a remote monitoring subsystem. In other embodiments, the processing subsystem may receive instruction from the remote monitoring subsystem to indicate an alarm condition signifying a tamper state. In certain embodiments, the tamper state may be indicated visually such as a flashing LED. In other embodiments, the tamper state may be indicated audibly such as a beeper or siren. In other embodiments, the tamper state may be indicated visually and audibly.

In certain embodiments, the inner container includes a monitoring subsystem for monitoring the filling, transporting, and repurposing or disposing of the used, unused, and/or waste pharmaceutical containing materials deposited within the inner container. It should be recognized that the inner container may be filled with other materials beside the controlled pharmaceutical materials. In other embodiments, the inner container includes a tamper resistant sealing member. In other embodiments, the inner container also includes a pressure sensing subsystem for sensing a pressure of the collected materials in the inner container. In other embodiments, the inner container includes an inner liner. In other embodiments, the inner liner includes a sealing member. In other embodiments, the inner liner includes a pressure sensing subsystem disposed on a bottom portion of the inner liner for monitoring a pressure of the collected materials in the inner liner. In other embodiments, the inner container includes a processing subsystem for storing pressure and other inner container data. In other embodiments, the processing subsystem includes communication hardware and software for transmitting inner container data to a remote monitoring subsystem. In other embodiments, the processing subsystem may receive instruction from the remote monitoring subsystem to indicate an alarm condition signifying a tamper state. In certain embodiments, the tamper state may be indicated visually such as a flashing LED. In other embodiments, the tamper state may be indicated audibly such as a beeper or siren. In other embodiments, the tamper state may be indicated visually and audibly.

### Suitable Reagents and Materials

### Unidirectional Opening Members

Suitable container shapes include, without limitation, a polygonal solid such as a rectangular solid, such as a box; a cylinder such as a barrel; a sphere; an ellipsoidal solid; a trapezoidal solid; any other geometrically shaped container or mixtures or combinations thereof.

Suitable opening shapes include, without limitation, circular, ellipsoidal, polygonal such as a triangular opening, a square opening, rectangular opening, a hexagonal opening, etc., any other opening shape, and/or mixtures or combinations thereof.

Suitable unidirectional apparatus include, without limitation, any structure that permits depositing into an interior of a container, while resisting normal attempts at withdrawal of materials deposited therein. Without limiting the structures of the unidirectional apparatus suitable for use in this invention, a set of structures are set forth below referred to herein is first type, second type, third type, fourth type, fifth type, sixth type and seventh type unidirectional apparatus designed to permit deposition into an interior of a container, while resisting normal attempts at withdrawal of materials deposited therein. A container may include one unidirectional apparatus or combination of unidirectional apparatuses. For additional details concerning unidirectional apparatuses for depositing source pharmaceutical material into the inner container of the collection apparatuses, the reader is referred to U.S. Pat. No. 8,324,443 issued 4 Dec. 2012.

A first type of unidirectional apparatuses include having a plurality of radial slits, where the member can be any regular or irregular shape and the radial slits extend from a center of the member outward to a boundary for affixing the member into the top of the container. The first type of unidirectional apparatuses are sometimes referred to as radially slitted unidirectional apparatuses. In certain embodiments, the member is flat or substantially flat (less than about 5% deflection from flat).

A second type of unidirectional apparatus includes a flat or substantially flat member (less than about 5% deflection from flat) having one longitudinal, lateral, or slanted slit or a plurality of such slits, where the member can be any regular or irregular shape, and the slits extend between a boundary for affixing the member into the top of the container. The second type of unidirectional apparatuses are sometimes referred to as non-radially slitted unidirectional apparatuses. When a member includes a plurality of slits, the slits may be arranged in a pattern.

A third type of unidirectional apparatus includes a housing having an opening in its top and a slidable member disposed in an interior of the housing. The slidable member includes a hollow cavity within which material can be placed. The slidable member is slidable within the housing by a handle attached to the slidable member and movable within a longitudinal slot in the housing. Once material is placed within the hollow cavity, the slidable member is moved so that the hollow member aligned with an opening in the top of the container such that the material falls into an interior of the container. This type of unidirectional apparatus restricts normal attempts to withdraw deposited materials. The third type of unidirectional apparatuses are sometimes referred to as slidable unidirectional apparatuses.

A fourth type of unidirectional apparatus includes a rotatable member having an opened interior. Material is placed in the interior of the rotatable member. The rotatable member is rotated 180° resulting in the material in the interior being deposited in the interior of the container. This type of unidirectional apparatus restricts normal attempts to withdraw deposited materials. The fourth type of unidirectional apparatuses are sometimes referred to as rotatable unidirectional apparatuses.

A fifth type of unidirectional apparatus includes a flat or substantially flat member (less than about 5% deflection from flat) having one or a plurality of arcuate slits and tabs, where the arcuate slits form portions of member that can rotate about tabs allowing material to pass into the interior of the container, while resisting normal attempts to withdraw deposited material. The fifth type of unidirectional apparatuses are sometimes referred to as arcuate slitted unidirectional apparatuses.

A sixth type of unidirectional apparatus includes at least one biased slidable member including a handle mounted in an opening in the top of the container. When the slidable member is moved to open the opening, the biased member is compressed. Once material is placed into the container through the opening, the slidable member is released and the biased member quickly restores the slidable member to its closed state. This type of apparatus permits material deposition, while resisting normal attempts to withdraw deposited material. The sixth type of unidirectional apparatuses are sometimes referred to as biased unidirectional apparatuses.

A seventh type of unidirectional apparatus includes a chute including baffles mounted in an opening in the top of the container. The seventh type of unidirectional apparatus also includes a chute having a spiraled configuration. The seventh type of unidirectional apparatus also includes a chute having a zig-zag configuration. The seventh type of unidirectional apparatus also includes a chute having any other configuration that resists normal attempts to withdraw deposited materials from the interior of the container.

For unidirectional apparatus that include a flat member, suitable flat member can be, without limitation, rigid members, semi-rigid members, flexible members, resilient members, and/or mixture or combinations thereof. In certain embodiments, the members are constructed out of corrugated plastic materials.

### Locks

Suitable locks for use with the outer containers or with inner container if they are locked include, without limitation, any lockable apparatus including combination locks, shielded combination locks, keypad locks, pad locks, shielded pad locks, ring locks, key locks, biometric locks that use fingerprints, palm prints, retinal scans or other biometric features that may be used to open or close a lockable apparatus. The lockable apparatuses may be a combination of any of these lock types. Thus, the lockable apparatus may include a key pad and a finger print recognition pad or a retinal scan and a combination lock. The lockable apparatus may use a member or members that rotate into slots, a dead bolt or dead bolts that insert into apertures, a spring loaded member or spring load members, a magnetic and/or electromagnetic locking member or members, or combinations thereof.

### Monitoring, Tracking and Communications Hardware and Software

Suitable monitoring, tracking and communications hardware and software include, without limitation, cameras, IR imaging apparatuses, sonic imaging apparatuses, passive and active radio frequency tags, IR transmitters, sonic transmitters, lasers, masers, wireless communication hardware and software such as cell phone technology, radio transmitting hardware and software, wired communications hardware and software such as telephone lines, high speed data lines, or similar wired hardware or software equipment, intranet wired and/or wireless communication networks, internet wired and/or wireless communication networks, or mixtures thereof.

### Digital Processing Units

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Erricsson, HP, Samsung, Hitachi, NRC, Applied Materials, AMD, Cyrix, Sun Microsystem, Philips, National Semiconductor, or any other manufacture of microprocessors or microcontrollers. The DPU devices are capable of receiving, transmitting and analyzing data from collections apparatuses, outer containers, and/or inner containers.

### Analog Processing Units

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc. The APU devices are capable of receiving, transmitting and analyzing data from collections apparatuses, outer containers, and/or inner containers.

### Motion Sensing Apparatus

The optical sensors can also be used as optical touch or touchless pads for notebook computer or drawing tablets. The optical sensors can also be digital or analog camera systems with focal plane set to sense motion within a zone, area or volume in front of the lens. The optical sensors can be operated in any region of the electromagnetic spectrum including, without limitation, RF, microwave, near IR, IR, far IR, visible, UV or mixtures or combinations thereof. Moreover, LCD screen(s) may be incorporated to identify which devices are chosen or the temperature setting, etc. Moreover, the interface can project a virtual control surface and sense motion within the projected image and invoke actions based on the sensed motion. The motion sensor associated with the interfaces of this invention can also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform could be used to discern motion and any sensor measuring gravitational, magnetic, electro-magnetic, or electrical changes relating to motion could be used. Of course, the interfaces can include mixtures or combinations of any known or yet to be invented motion sensors.

Suitable motion sensing apparatus include, without limitation, motion sensors of any form such as digital cameras, optical scanners, optical roller ball devices, touch pads, inductive pads, capacitve pads, holographic devices, laser tracking devices, thermal devices, EMF sensors, wave form sensors, any other device capable of sensing motion, changes in EMF, changes in wave form, or the like or arrays of such devices or mixtures or combinations thereof.

### Biometric Locking Devices

Suitable biometric locking devices include fingerprint recognition locking systems, retinal recognition locking systems, palm recognition locking systems, voice recognition locking systems, face recognition locking systems, other biometric recognition locking systems, or mixtures or combinations thereof. Suitable United States manufacturers include, without limitation, Security Solutions, Mustang, Okla.; Keri Systems, Inc., San Jose, Calif.; Time Clocks and More, Deland, Fla.; Time & Parking Controls, Upper Darby, Pa.; Vector Security, Lancaster, Pa.; Control Module, Inc., Enfield, Conn.; Security Management Systems, Great Neck, N.Y.; Lumidigm Inc, Albuquerque, N. Mex.; RF Logics Inc, Torrance, Calif.; Sielox, Runnemede, N.J.; Rayco Security Inc., Van Nuys, Calif.; Mace Security International, Inc., Mount Laurel, N.J.; Access Controls International Awarded Security System, Freehold, N.J.; ekeyUSA Systems LLC, Bradenton, Fla.; Fulcrum Biometrics, San Antonio, Tex.; David-Link Fingerprint USA Corp., City Of Industry, Calif.; Hirsch Identive, Santa Ana, Calif.; Federal Surveillance Systems, Newark, N.J.; M2SYS LLC., Atlanta, Ga.; MAXxess Systems, Inc., Anaheim, Calif.; Vertex, Inc., New York, N.Y.; Professional Lock Systems, Long Beach, Calif.; FaceKey Corp., San Antonio, Tex.; ISSCO Industrial Security Systems & Controls, Westbury, N.Y.; LiGER Security, Toronto, ON; Global Technical Systems, Virginia Beach, Va.; Biolock USA, Camarillo, Calif.; SAMCO Time Recorders, Inc., Bogota, N.J.; Sensormatic Hawaii, Inc., Aiea, Hi.; Acroprint Time Recorder Co., Raleigh, N.C.; AuthenTec, Melbourne, Fla.; Identix, Inc., Minnetonka, Minn.; Dataflo Consulting, Omaha, Nebr.; Wornall, Kansas City, Mo.; Indigo Systems, Portland, Oreg.; Mid Florida Security, Lakeland, Fla.; PM Locks, Oklahoma City, Okla.; Phileo Inc., Fort Lee, N.J.; LSI (Lamination Service, Inc.), Memphis, Tenn.; DSX Access Systems, Inc., Dallas, Tex.; US Biometrics Corp., Naperville, Ill.; Fingergear, Mountain View, Calif.; MaxID Corp., Reston, Va.; and Identica Holdings Corp, Tampa, Fla. There are many off source manufacturers as well.

### Container Construction Materials

Suitable materials used in the construction of the containers of this invention include, without limitation, pulp materials, polymer materials, fibrous materials, fabric material, metallic materials, ceramic materials, composite materials, and/or mixtures or combinations thereof. The containers may also be coated with a coating material before and/or after being filled. The construction materials may also be coated with a coating material before and/or during construction.

### Over-the-counter (OTC) Pharmaceutical Materials

Suitable OTC pharmaceutical materials include, without limitation, acetaminophen, acetanilide, agar, alcloxa, aldioxa, alfalfa, alfalfa leaves, alginic acid, alkyl dimethyl amine oxide and alkyl dimethyl glycine, alkyl isoquinolinium bromide, allantoin, allyl isothiocyanate, almadrate sulfate, aloin, alpha cellulose, alum, ammonium, alum, potassium, alumina powder, hydrated, aluminum acetate, aluminum bromohydrate, aluminum carbonate gel (basic), aluminum chlorhydroxy complex, aluminum chloride (alcoholic solutions), aluminum chloride hexahydrate, aluminum chlorohydrate, aluminum chlorohydrex, aluminum chlorohydrex polyethylene glycol, aluminum chlorohydrex propylene glycol, aluminum dichlorohydrate, aluminum dichlorohydrex polyethylene glycol, aluminum dichlorohydrex propylene glycol, aluminum hydroxide, aluminum hydroxide gel, aluminum hydroxide-hexitol, stabilized polymer, aluminum hydroxide-magnesium carbonate, co-dried gel, aluminum hydroxide-magnesium trisilicate, co-dried gel, aluminum hydroxide-sucrose powder hydrated, aluminum phosphate, aluminum phosphate gel, aluminum sesquichlorohydrate, aluminum sesquichlorohydrate poylethylene glycol, aluminum sesquichlorohydrate propylene glycol, aluminum sulfate, aluminum sulfate, aluminum zirconium octachlorohydrate, aluminum zirconium octachlorohydrex gly, aluminum zirconium pentachlorohydrate, aluminum zirconium pentachlorohydrex gly, aluminum zirconium tetrachlorohydrate, aluminum zirconium tetrachlorohydrex gly, aluminum zirconium trichlorohydrate, aluminum zirconium trichlorohydrex gly, amiloxate (isoamyl p-methoxycinnamate), aminacrine hydrochloride, aminoacetic acid, aminobenzoic acid, aminobenzoic acid (PABA), aminophylline, ammoniated mercury, ammonium bromide, ammonium chloride, ammonium chloride, ammonium hydroxide, amylase, amyltricresols, anise oil, anise seed, antimony potassium tartrate, antipyrine, atropine, arginine, aromatics, asafetida, asclepias tuberosa, ascorbic acid, asparagus, aspergillus oryza enzymes, aspirin, atropa belladonna, atropine, atropine sulfate, attapulgite, activated, avobenzone, bacillus acidophilus, bacitracin, bacitracin zinc, barosma, basic fuchsin, beachwood creosote, bearberry, beeswax, belladonna alkaloids, belladonna extract, belladonna leaves, powdered extract, bemotrizinol, benzalkonium chloride, benzocaine, benzoic acid, benzoin preparations, benzoin tincture, benzonatate, benzoxiquine, benzoyl peroxide, benzyl alcohol, benzyl benzonate, betaine hydrochloride, bile salts/acids, biotin, bisacodyl, bismuth aluminate, bismuth carbonate, bismuth oxide, bismuth sodium tartrate, bismuth subcarbonate, bismuth subgallate, bismuth subnitrate, bismuth subsalicylate, bisoctrizole, bithionol, black radish powder, blessed thistle (cnicus benedictus), bone marrow, red, boric acid, bornelone (5-(3,3-dimethyl-2-norbornyliden)3-pentene-2-one), bornyl acetate (topical), boroglycerin, bran, brompheniramine maleate, buchu powdered extract (extract of buchu), buchu, potassium extract, buckthorn, butacaine sulfate, butamben picrate, caffeine, caffeine citrate, calamine, calcium, calcium (mono or dibasic salt), calcium acetate, calcium carbonate, calcium caseinate, calcium gluconate, calcium hydroxide, calcium lactate, calcium pantothenate, calcium phosphate, calcium polycarbophil, calcium polysuldfide, calcium salicylate, calcium sucrose phosphate, calcium thiosulfate, calcium undecylenate, calomel, calomel (mercurous chloride), camphor, camphorated metacresol, candicidin, capsaicin, capsicum, capsicum oleoresin, captan, caramiphen edisylate, carbamide peroxide, carbaspirin calcium, carbetapentane citrate, carboxymethylcellulose sodium, carrageenan, casanthranol, cascara extract, cascara sagrada bark, cascara sagrada extract, castor oil, catechu, tinctures, catnip, cedar leaf oil (topical), cellulase, cellulose, microporous, cetalkonium chloride, cetyl alcohol, cetylpyridinium chloride, chlophedianol hydrochloride, chloral hydrate, chlorcyclizine hydrochloride, chlorhydroxyquinoline (cloxyquin), chlorobutanol, chloroform, chlorophenothane (dichlorodiphenyl trichloroethane), chlorophyllin, chlorophyllin copper complex, chlorophyllin copper complex, chlorothymol, chloroxlyneol, chlorpheniramine maleate, chlorprophenpyridamine maleate, chlortetracycline hydrochloride, cholecalciferol, cholecalciferol (vitamin D), choline, choline salicylate, chondrus, cimicifuga racemosa, cinnamedrine hydrochloride, cinnamon oil, cinnamon tincture, digestive aid, cinoxate, citrate, citric acid, citrus pectin, clioquinol, cloflucarban, clotrimazole, clove oil, cloxyquin (chlorhydroxyquinoline), cnicus benedictus, coal tar, cocoa butter, coconut oil soap, cod liver oil, codeine, codeine phosphate, codeine sulfate, collinsonia extract, colloidal oatmeal, colocynth, copper, copper gluconate, copper oleate, copper undecylenate, corn oil, corn silk, corn starch, corn syrup, couch grass, creosote, creosote, beechwood, cresol, cresol, saponated, cupric sulfate, cyanocobalamin (vitamin B12), cyclizine hydrochloride, cyclomethycaine sulfate, cysteine hydrochloride, cystine, danthron, datura stramonium, dehyrocholic acid, dequalinium chloride, dexbromopheniramine maleate, dexchlorpheniramine maleate, dexpanthenol, dextran 70, dextromethorphan, dextromethorphan hydrobromide, dextrose, diastase, diastase malt, digestive aid, dibenzothiophene, dibucaine, dibucaine hydrochloride, dicalcium phosphate dihydrate, dichlorodiphenyl trichloroethane (DDT), dichlorophen, diethylhexyl butamido triazone, digalloyl trioleate, dihydroxyaluminum aminoacetate, dihydroxyaluminum aminoacetic acid, dihydroxyaluminum sodium carbonate, dimenhydrinate, dimethicone, dimethisoquin hydrochloride, dioctyl sodium sulfosuccinate, diolamine methoxycinnamate (diethanolamine methoxycinnamate), dioxybenzone, diperodon, diperodon hydrochloride, diphenhydramine citrate, diphenhydramine hydrochloride, dipropylene glycol salicylate, disodium hydrogen phosphate, docusate calcium sulfosuccinate, docusate potassium sulfosuccinate, docusate sodium, docusate sodium sulfosuccinate, dodecaethylene glycol monolaurate, dog grass, dog grass extract, domiphen bromide, doxylamine succinate, drometrizole trisiloxane, duodenal substance, dyclonine hydrochloride, ecamsule, edetate disodium, elaterin resin, elecampane, elm bark, ensulizole (phenylbenzimidazole sulfonic acid), enzacamene (4-methylbenzylidene camphor), ephedrine, ephedrine hydrochloride, ephedrine sulfate, epinephrine, epinephrine bitartrate, epinephrine hydrochloride, epinephrine undecylenate, ergocalciferol, ergot fluid extract, Escherichia coli vaccine, estrone, ethohexadiol, ethyl 4-[bis(hydroxypropyl)] aminobenzoate (roxadimate), ethyl nitrate, ethylmorphine hydrochloride, eucalyptol, eucalyptus oil, eugenol, euphorbiapilulifera, fennel acid, ferric acid, ferric ammonium citrate, ferric chloride, ferric pyrophosphate, ferric subsulfate (Monsel's solution), ferrous fumarate, ferrous gluconate, ferrous sulfate, flax seed, fluorosalan, folic acid, formaldehyde solution, formic acid, frangula, fructose, galega, gamboge, garlic, dehydrated, gelatin, gentian violet, gentiana lutea (gentian), ginger, ginseng, glutamic acid hydrochloride , glycerin, glyceryl aminobenzoate (lisadimate, glyceryl PABA), glyceryl stearate, glycine, glycol salicylate, glycyrrhiza (licorice), gramicidin, guaifenesin, guar gum, haloprogin, hard fat, hectorite, hemicellulase, hexachlorophene, hexylresorcinol, histamine dihydrochloride, histidine , homatropine methylbromide, homosalate, horehound, horsetail, huckleberry, hydrastis, hydrastis canadensis, hydrate magnesium aluminate activated sulfate, hydrochloric acid, hydrocodone bitartrate, hydrocortisone, hydrocortisone acetate, hydrogen fluoride, hydrogen peroxide, hydroquinone, hydroxyethylcellulose, hydroxypropyl methycellulose, hyocyamine sulfate, hyoscyamine sulfate, hypromellose, ibuprofen, ichthammol, impatiens biflora tincture, infusion of rose petals, inositol, iodides, iodine, iodine tincture, iodoantipyrine (idopyrine), ipecac, ipecac syrup, ipomea, iron ox bile, iron oxide, isobornyl thiocycanoacetate, isoleucine, isopropyl palmitate, jalap, johnswort, juniper oil (oil of juniper), juniper tar, juniper, potassium extract, kaolin, karaya gum, kelp, knotgrass, lactic acid, Lactobacillus acidophilis, Lactobacillus bulgaricus, lactose, lanolin, lappa extract, laureth 10S, lauryl isoquinolinium bromide, lavender compound, lawsone (w/ dihydroxyacetone), lead acetate, lecithin, leptandra extract, leucine, levmetamfetamine, lidocaine, lidocaine hydrochloride, linden, lipase, live yeast cell derivative, liver concentrate, lysine, lysine aspirin, lysine hydrochloride, magaldrate, magnesium, magnesium aluminosilicate, magnesium aluminum silicate, magnesium carbonate, magnesium citrate (oral), magnesium glycinate, magnesium hydroxide, magnesium oxide, magnesium salicylate, magnesium sulfate, magnesium trisilicate, malt, malt soup extract, maltodextrin, manganese citrate, mannitol, m-cresol, meclizine hydrochloride, menfegol, menthol, meradimate (menthyl anthranilate), meralein sodium, merbromin (mercurochrome), mercufenol chloride, mercuric chloride, mercuric oxide, mercuric salicylate, mercuric sulfide, mercury, mercury oleate, mercury sulfide, mercury, ammoniated, metaproterenol sulfate, methapyrilene fumarate, methapyrilene hydrochloride, methenamine, methionine, methoxyphenamine hydrochloride, methoxypolyoxyethyleneglycol 550 laurate, methyl nicotinate, methyl salicylate, methylbenzethonium chloride, methylcellulose, methylene blue, methylparaben, miconazole nitrate, mild silver protein, milk solids, dried, minaeral oil, mineral oil, mono- and di-glycerides, mullein, mustard oil (alltlishthiocyanate), mycozyme, myrrh, naphazoline hydrochloride, natural estrogenic horomone, neomycin ointment, neomycin sulfate, nettle, niacinamide, nickel-pectin, nitromersol, nonoxynol 9, nonylphenoxypoly (ethyleneoxy) ethanol iodine, noscapine, noscapine hydrochloride, nutmeg oil (oil of nutmeg), nux vomica extract, nystatin, obtundia surgical dressing, octinoxate (octyl methoxycinnamate; ethylhexyl methoxycinnamate), octisalate (octyl salicylate; ethylhexyl salicylate), octocrylene, octoxynol 9, octyl triazone (ethylhexyl triazone), Opium powder, Opium tincture, orthophosphoric acid, ox bile, ox bile extract, oxybenzone (benzophenone-3), oxymetazoline hydrochloride, oxyquinoline, oxyquinoline sulfate, oxytetracycline hydrochloride, padimate a, padimate o, pamabrom, pancreatin, pancrelipase, panthenol, pantothenic acid, papain, papaya enzymes, papaya, natural, para-chloromercuriphenol, paraffin, paregoric, parethoxycaine hydrochloride, parsley, passion flower extract, pectin, peppermint, peppermint oil, peppermint spirit, pepsin, peruvian balsam, peruvian balsam oil, petrolatum, phenacaine hydrochloride, phenacetin, phenindamine tartrate, pheniramine maleate, phenobarbital, phenol, phenolate sodium, phenolphthalein, phenoxyacetic acid, phenyl salicyiate, phenylalanine, phenylephrine bitartrate, phenylephrine hydrochloride, phenylmercuric acetate, phenylmercuric nitrate, phenylpropanolamine bitartrate, phenylpropanolamine hydrochloride, phenylpropanolamine maleate, phenyltoloxamine citrate, phenyltoloxamine dihydrogen citrate, phenyltoloxamine hydrochloride, phosphorated carbohydrate, phosphoric acid, phosphorus, phytolacca, picrotoxin, pine tar, pineapple enzymes, piperazine citrate, piperocaine hydrochloride, piperonyl butoxide (combination), pipsissewa, piscidia erythrina, plantago ovata husks, plantago seed, plantago seed husks, podophyllum resin (podophyllin), poloxamer, poloxamer 188, poloxamer 407, poloxamer-iodine complex, polycarbophil, polydimethylsiloxane and poloxamer, polyethylene glycol 300, polyethylene glycol 400, polyethylene glycol 6000, polymyxin b sulfate, polyoxeythylene laurate, polysorbate 80, polyvinyl alcohol, potassium acetate, potassium bicarbonate, potassium bromide, potassium carbonate, potassium chlorate, potassium citrate, potassium ferrocyanide, potassium guaiacolsulfonate, potassium iodide, potassium nitrate, potassium salicylate, povidone, povidone-iodine, povidone-vinylacetate copolymers, pramoxine hydrochloride, precipitated sulfur, prolase, propionic acid, propylene glycol, propylhexedrine, propylparaben, protease, protein hydrolysate, prune concentrate dehydrate, prune powder, pseudoephedrine hydrochloride, pseudoephedrine sulfate, psyllium (hemicellulose), psyllium hydrophilic mucilloid, psyllium seed, psyllium seed husks, p-t-butyl-m-cresol, pyrantel pamoate, pyrethrum extract, pyridoxine hydrochloride, pyridoxine hydrochloride (vitamin B6), pyrilamine maleate, pyrithione zinc, quinine, racemethionine, racephedrine hydrochloride, red petrolatum, reosote, resorcinol, rhubarb fluid extract, riboflavin, rice polishings, sabadilla, alkaloids, saccharin, sage oil, salicyl alcohol, salicylamide, salicylic acid, salsalate, sanguinaria extract, saw palmetto, scopolamine aminoxide hydrobromide, scopolamine hydrobromide, sea minerals, selenium sulfide, senecio aureus, senna, senna pod concentrate, senna syrup, sennosides a and b, sesame seed, shark liver oil, silver nitrate, simethicone, sodium 3, 4-dimethylphenyl-glyoxylate, sodium acetylsalicylate, sodium aluminum chlorohydroxy lactate, sodium benzoate, sodium bicarbonate, sodium borate, sodium borate monohydrate, sodium bromide, sodium caprylate, sodium carbonate, sodium carboxymethylcellulose, sodium caseinate, sodium citrate, sodium diacetate, sodium dichromate, sodium dihydrogen phosphate, sodium dihydrogen phosphate monohydrate, sodium fluoride, sodium monofluorophosphate, sodium nitrate, sodium oleate, sodium para-aminobenzoate, sodium perborate, sodium perborate monohydrate, sodium phosphate, sodium phosphate, dibasic, sodium phosphate, monobasic, sodium potassium tartrate, sodium propionate, sodium salicylate, sodium salicylic acid phenolate, sodium sulfide, sodium thiosulfate, soopolamine hydrobromide, sorbitol, soy meal, soybean oil, hydrogenated (powder), soybean protein, squill preparations (squill, squill extract), stannous fluoride, stannous pyrophosphate and zinc citrate, stearyl alcohol, strontium chloride, strychnine, sublimed sulfur, sucrose, sulfacetamide sodium, sulferated oils of turpentine, sulfur, sulisobenzone, talc, tannic acid, tannic acid glycerite, taraxacum officinale, tartaric acid, terpin hydrate prearations (terpin hydrate, terpin hydrate elixer), tetracaine, tetracaine hydrochloride, tetracycline hydrochloride, tetrahydrozoline hydrochloride, thaimine hydrochloride (vitamin B1), thaimine mononitrate (vitamine B1 mononitrate), thenyldiamine hydrochloride, theobromine sodium salicylate, theophylline, theophylline calcium salicylate, theophylline sodium glycinate, thiamine hydrochloride, thimerosal, thiocyanoacetate, thonzylamine hydrochloride, threonine, thymol, thymol iodide, titanium dioxide, tolindate, tolnaftate, tolu balsam, topical starch, triacetin, tricalcium phosphate, triclocarban, triclosan, trillium, tripelennamine hydrochloride, triple dye, triprolidine hydrochloride, triticum, trolamine, trolamine salicylate, tryptophan, turpentine oil, turpentine, tyrosine, undecoylium chlorideiodine complex, undecylenic acid, urea, uvaursi, extract of, uvaursi, potassium extract, valine, vitamin A, vitamin A acetate, vitamin A palmitate, vitamin E, vitromersol, wax, white, wax, yellow, wheat germ, white ointment, white petrolatum, witch hazel, woodruff, xanthan gum, xylometazoline hydrochloride (aqueous), yeast, yeast cell derivative, live, yellow mercuric oxide, zinc acetate, zinc caprylate, zinc carbonate, zinc chloride, zinc citrate, zinc oxide, zinc phenol sulfonate, zinc propionate, zinc stearate, zinc undecylenate, zirconium oxide, zyloxin, any other FDA approved OTC pharmaceutical, and mixtures or combinations thereof.

### Prescription Pharmaceutical Materials

Suitable prescription pharmaceutical materials include, without limitation, Abilify (aripiprazole), Abraxane (paclitaxel protein-bound particles for injectable suspension), ABREVA (docosanol), Abstral (fentanyl sublingual tablets), Accolate, Accolate, Accretropin (somatropin rDNA Original), Aciphex (rabeprazole sodium), Actemra (tocilizumab), Actemra (tocilizumab), Actiq, Activella (Estradiol/Norethindrone Acetate) Tablets, Actonel, ACTOplus met (pioglitazone hydrochloride and metformin hydrochloride), ACTOS, Acular (ketorolac tromethamine ophthalmic solution) 0.5%, Acular (ketorolac tromethamine ophthalmic solution) 0.5%, Acuvail (ketorolac tromethamine), Acyclovir Capsules, Adcirca (tadalafil), Adcretris (brentuximab vedotin), Adderall (mixed salts of a single-entity amphetamine), Adderall XR, Advicor (extended-release niacin/lovastatin), Afinitor (everolimus), Afinitor (everolimus), Afinitor (everolimus), Afinitor (everolimus), Agenerase (amprenavir), Aggrenox, Agrylin (anagrelide HCL), Agrylin (anagrelide HCL), AK-Con-A (naphazoline ophthalmic), Alden (lidocaine hydrochloride), Alamast, Albenza (albendazole), Aldara (imiquimod), Aldurazyme (laronidase), Alesse (100 mcg levonorgestrel/20 mcg ethinyl estradiol tablets), Alimta (pemetrexed for injection), Alinia (nitazoxanide), Allegra (fexofenadine hydrochloride), Allegra-D, Alora, Aloxi (palonosetron), Alphagan (brimonidine), AlphaNine SD Coagulation Factor IX (Human), Alrex, Altabax (retapamulin), Altocor (lovastatin) Extended-Release Tablets, Alvesco (ciclesonide), Amaryl (Glimepiride), Amerge, Amevive (alefacept), Amitiza (lubiprostone), Amoxil (amoxicillin), Ampyra (dalfampridine), Amrix (cyclobenzaprine hydrochloride extended release), Amturnide (aliskiren+amlodipine+hydrochlorothiazide), Androderm (Testosterone Transdermal System), AndroGel testosterone gel, AneuVysion Assay, Anexsia, Angiomax (bivalirudin), Antizol Injection, Anturol (oxybutynin) Gel, Anzemet, Anzemet, Aphthasol, Aplenzin (bupropion hydrobromide), Apokyn (apomorphine hydrochloride), Apthasol (Amlexanox), Aptivus (tipranavir), Aptivus (tipranavir), Arava, Arcapta (indacaterol maleate inhalation powder), Aredia (pamidronate disodium for injection), Arestin (minocycline hydrochloride), Argatroban Injection, ARICEPT (donepezil hydrochloride), Arimidex (anastrozole), Arixtra, Aromasin Tablets, Arranon (nelarabine), Arthrotec, Arzerra (ofatumumab), Asacol (mesalamine), Astelin nasal spray, Astepro (azelastine hydrochloride nasal spray), Atacand (candesartan cilexetil), Atacand (candesartan cilexetil), Atacand (candesartan cilexetil), Atracurium Besylate Injection, Atridox, Atridox, Atrovent (ipratropium bromide), Atryn (antithrombin recombinant lyophilized powder for reconstitution), Aubagio (teriflunomide), Augmentin (amoxicillin/clavulanate), Avandamet (rosiglitazone maleate and metformin HCl), Avandia (rosiglitazone maleate), Avastin (bevacizumab), Avastin (bevacizumab), Avelox I.V. (moxifloxacin hydrochloride), Avinza (morphine sulfate), Avita Gel, Avita Gel, Avonex (Interferon Beta 1-A), Axert (almotriptan malate) tablets, Axid AR (nizatidine, Axona (caprylidene), AzaSite (azithromycin), Azmacort (triamcinolone acetonide) Inhalation Aerosol, Azor (amlodipine besylate; olmesartan medoxomil), Azulfidine EN-tabs Tablets (sulfasalazine delayed release tablets, USP), Bactroban Cream, Bactroban Nasal 2% (mupirocin calcium ointment), Banzel (rufinamide), Baraclude (entecavir), Baycol (cerivastatin sodium), Bayer Extra Strength Asprin, Belviq (lorcaserin hydrochloride), BeneFIX (coagulation Factor IX (recombinant)), BeneFIX (coagulation Factor IX (recombinant)), Benicar, Benlysta (belimumab), Benzamycin (erythromycin 3%-benzoyl peroxide 5% topical gel), Bepreve (bepotastine besilate ophthalmic solution), Berinert (C1 Esterase Inhibitor (Human)), Besivance (besifloxacin ophthalmic suspension), Betaxon, Bextra, Bexxar, Biaxin XL (clarithromycin extended-release tablets), BiDil (isosorbide dinitrate/hydralazine hydrochloride), Bio-T-Gel (testosterone gel), Boniva (ibandronate), Bosulif (bosutinib), Botox (onabotulinumtoxinA), Botox (onabotulinumtoxinA), Botox Cosmetic (botulinum toxin type A), Bravelle (urofollitropin for injection, purified), Breathe Right, Brilinta (ticagrelor), Bromfenac, Brovana (arformoterol tartrate), BSS Sterile Irrigating Solution, Busulflex, Butrans (buprenorphine) Transdermal System, Byetta (exenatide), Caduet (amlodipine/atorvastatin), Cafcit Injection, Cambia (diclofenac potassium for oral solution), Campath, Campostar, Campral (acamprosate calcium), Camptosar, Canasa (mesalamine), Cancidas, Captopril and hydrochlorotiazide, Captopril and hydrochlorotiazide, Carbaglu (carglumic acid), Carbatrol, Cardizem (R) (Diltiazem HCl for injection) Monvial (R), Carrington patch, Caverject (alprostadil), Cayston (aztreonam for inhalation solution), CEA-Scan, Cedax (ceftibuten), Cefazolin and Dextrose USP, Ceftin (cefuroxime axetil), Celexa, CellCept, Cenestin, Cenestin, Cemevit, Cervarix [Human Papillomavirus Bivalent (Types 16 and 18) Vaccine, Recombinant, Cetrotide, Chantix (varenicline), Children's Advil (pediatric ibuprofen), Children's Motrin Cold, Chloraprep (chlorhexidine gluconate), Cialis (tadalafil), Cimetadine Hydrochloride Oral Solution 300 mg/5 ml, Cimetidine Hydrochloride Oral Solution, Cimetidine Hydrochloride Oral Solution, Cimzia (certolizumab pegol), Cimzia (certolizumab pegol), Cinryze (C1 Inhibitor (Human)), Cipro (ciprofloxacin HCl), Cipro (ciprofloxacin HCl), Cipro (ciprofloxacin) I.V. and Cipro (ciprofloxacin HCl) tablets, Clarinex, Clarithromycin (Biaxin), Claritin RediTabs (10 mg loratadine rapidly-disintegrating tablet), Claritin Syrup (loratadine), Claritin-D 24 Hour Extended Release Tablets (10 mg loratadine, 240 mg pseudoephedrine sulfate), Clemastine fumarate syrup, Cleocin (clindamycin phosphate), Cleocin (clindamycin phosphate), Cleviprex (clevidipine), Climara, Clindamycin phosphate topical gel, Clindamycin Phosphate Topical Solution USP 1%, Clolar (clofarabine), Clomipramine hydrochloride, Clonazepam, Coartem (artemether/lumefantrine), Colazal (balsalazide disodium), Colcrys (colchicine), Combivir, Complera (emtricitabine/rilpivirine/tenofovir disoproxil fumarate), Comtan, Concerta, Condylox Gel 0.5% (pokofilox), Confide, Copaxone, Corlopam, Corvert Injection (ibutilide fumarate injection), Cosopt, Covera-HS (verapamil), Crestor (rosuvastatin calcium), Crinone 8% (progesterone gel), Crixivan (Indinavir sulfate), Curosurf, Cuvposa (glycopyrrolate), Cycloset, bromocriptine mesylate, Cylert, Cymbalta (duloxetine), Cystaran (cysteamine hydrochloride), Dacogen (decitabine), Daliresp (roflumilast), Daptacel, Degarelix (degarelix for injection), DentiPatch (lidocaine transoral delivery system), Depakote (divalproex sodium), Depakote (divalproex sodium), Depakote ER (divalproex sodium), Dermagraft-TC, Desmopressin Acetate (DDAVP), Desmopressin Acetate (DDAVP), Desonate (desonide), Detrol (tolterodine tartrate), Detrol LA (tolterodine tartrate), Differin (adapalene gel) Gel, 0.1%, Dificid (fidaxomicin), Diltiazem HCL, Extended-Release Capsules, Diovan (valsartan), Diovan (valsartan), Diovan HCT (valsartan), Ditropan XL (oxybutynin chloride), Ditropan XL (oxybutynin chloride), Doribax (doripenem), Dostinex Tablets (cabergoline tablets), Doxil (doxorubicin HCl liposome injection), Droxia, Duexis (ibuprofen and famotidine), Dulera (mometasone furoate+formoterol fumarate dihydrate), DuoNeb (albuterol sulfate and ipratropium bromide), Durezol (difluprednate), dutasteride, Dymista (azelastine hydrochloride and fluticasone propionate), Dynabac, DynaCirc CR, Edarbi (azilsartan medoxomil), Edarbyclor (azilsartan medoxomil and chlorthalidone), EDEX, Edluar (zolpidem tartrate), Edurant (rilpivirine), Effexor (venlafaxin HCL), Effexor XR (venlafaxin HCl), Efient (prasugrel), Egrifta (tesamorelin for injection), Elaprase (idursulfase), Elelyso (taliglucerase alfa), Elestrin (estradiol gel), Elidel, Eligard (leuprolide acetate), Elitek (rasburicase), ella (ulipristal acetate), Ellence, Elliotts B Solution (buffered intrathecal electrolyte/dextrose injection), Elmiron (pentosan polysulfate sodium), Eloxatin (oxaliplatin/5-fluorouracil/leucovorin), Embeda (morphine sulfate and naltrexone hydrochloride), Emend (aprepitant), Enbrel (etanercept), Entereg (alvimopan), Entocort EC (budesonide), Epivir (lamivudine), Epivir (lamivudine), Eraxis (anidulafungin), Erbitux (cetuximab), Erivedge (vismodegib), Erwinaze (asparaginase Erwinia chrysanthemi), Esclim, Estradiol tablets, Estradiol tablets, Estradiol Transdermal System, Estratab (0.3 mg), EstroGel (estradiol gel 0.06%), Estrostep (norethindrone acetate and ethinyl estradiol), Estrostep (norethindrone acetate and ethinyl estradiol), Estrostep (norethindrone acetate and ethinyl estradiol), Ethyol (amifostine), Ethyol (amifostine), Etodolac, Etodolac, Etodolac, Eulexin (flutamide), Evamist (estradiol), Evista (raloxifene hydrochloride), Evista (raloxifene hydrochloride), Evista (raloxifene hydrochloride), Evoxac, Exalgo (hydromorphone hydrochloride) extended release, Excedrin Migraine, Exelon (rivastigmine tartrate), Exelon (rivastigmine tartrate), Exparel (bupivacaine liposome injectable suspension), Extavia (Interferon beta-1b), Extina (ketoconazole), Eylea (aflibercept), Fabrazyme (agalsidase beta), Famvir (famciclovir), Famvir (famciclovir), Fanapt (iloperidone), Faslodex (fulvestrant), Femara (letrozole), Femhrt Tablets, FemPatch, Femstat 3 (butoconazole nitrate 2%), FEMSTAT One, Fenofibrate, Feraheme (ferumoxytol), Feridex I.V., Ferriprox (deferiprone), Ferrlecit, Fertinex (urofollitropin for injection, purified), Finacea (azelaic acid) Gel, 15%, Finevin, Firazyr (icatibant), Flagyl ER, FLOMAX, Flonase Nasal Spray, Flovent Rotadisk, Floxin otic, Floxin Tablets (ofloxacin tablets), FluMist (Influenza Virus Vaccine), Fluzone Preservative-free, Focalin (dexmethylphenidate HCl), Follistim™ (follitropin beta for injection), Folotyn (pralatrexate injection), Foradil Aerolizer (formoterol fumarate inhalation powder), Forteo (teriparatide), Fortesta (testosterone gel), Fortovase, Fosamax (alendronate sodium), Fosrenol, lanthanum carbonate, Fragmin, Frova (frovatriptan succinate), Fusilev (levoleucovorin), Fuzeon (enfuvirtide), Galzin (zinc acetate), Gardasil (quadrivalent human papillomavirus (types 6, 11, 16, 18) recombinant vaccine), Gastrocrom Oral Concentrate (cromolyn sodium), GastroMARK, Gelnique (oxybutynin chloride), Gemzar (gemcitabine HCL), Gemzar (gemcitabine HCL), Generic Transdermal Nicotine Patch, Genotropin (somatropin) injection, Genotropin (somatropin) lyophilized powder, Geodon (ziprasidone mesylate), Geref (sermorelin acetate for injection), Gilenya (fingolimod), Gleevec (imatinib mesylate), Gleevec (imatinib mesylate), Gliadel Wafer (polifeprosan 20 with carmustine implant), Glipizide Tablets, Glucagon, Glucagon, Glyburide Tablets, Glyburide Tablets, Glyburide Tablets, Glyset (miglitol), Gonal-F (follitropin alfa for injection), Gralise (gabapentin), Halaven (eribulin mesylate), Havrix, Hectorol (Doxercalciferol) Injection, Hepsera (adefovir dipivoxil), Herceptin, Herceptin (trastuzumab), Hiberix (Haemophilus b Conjugate Vaccine; Tetanus Toxoid Conjugate), Horizant (gabapentin enacarbil), Horizant (gabapentin enacarbil), Humalog (insulin lispro), Humatrope (somatropin [rDNA origin] for injection), Humira (adalimumab), Hycamtin (topotecan hydrochloride), Hycamtin (topotecan hydrochloride), Iamin, Ilaris (canakinumab), Imagent (perflexane lipid microspheres), Imitrex (sumatriptan) injection and tablets, Imitrex (sumatriptan) nasal spray, Incivek (telaprevir), Increlex (mecasermin), INFANRIX (Diphtheria and Tetanus Toxoids and Acellular Pertussis Vaccine Adsorbed), Infasurf, INFERGEN (interferon alfacon-1), Inform HER-2/neu breast cancer test, Inlyta (axitinib), Innohep (tinzaparin sodium) injectable, Inspra (eplerenone tablets), Integrilin, Intelence (etravirine), Intermezzo (zolpidem tartrate sublingual tablet), Interstim Continence Control Therapy, Intron A (Interferon alfa-2b, recombinant), Intron A (interferon alfa-2b, recombinant), Intron A (interferon alfa-2b, recombinant), Intuniv (guanfacine extended-release), Invanz, Invega (paliperidone), Invirase (saquinavir), Iontocaine, Iressa (gefitinib), Isentress (raltegravir), Istodax (romidepsin), IvyBlock, Ixempra (ixabepilone), Ixiaro (Japanese Encephalitis Vaccine, Inactivated, Adsorbed), Jakafi (ruxolitinib), Jalyn (dutasteride+tamsulosin), Januvia(sitagliptin phosphate), Jentadueto (linagliptin plus metformin hydrochloride), Jevtana (cabazitaxel), Juvisync (sitagliptin and simvastatin), Kadian, Kalbitor (ecallantide), Kaletra Capsules and Oral Solution, Kalydeco (ivacaftor), Kapvay (clonidine hydrochloride), Keppra, Ketek (telithromycin), Ketoprofen, Kineret, Klaron (sodium sulfacet amide lotion) Lotion, 10%, Kogenate FS (Antihemophilic Factor Recombinant), Korlym (mifepristone), Krystexxa (pegloticase), Kuvan (sapropterin dihydrochloride), Kyprolis (carfilzomib), Kytril (granisetron) solution, Kytril (granisetron) tablets, Lamictal (lamotrigine) Chewable Dispersible Tablets, Lamictal Chewable Dispersible Tablets, Lamisil (terbinafine hydrochloride) Dermagel, 1%, Lamisil (terbinafine hydrochloride) Solution, 1%, Lamisil (terbinafine hydrochloride) Tablets, Lamisil Solution, 1%, Lantus (insulin glargine [rDNA origin] injection), Lantus (insulin glargine [rDNA origin] injection), Latuda (lurasidone), laViv (azficel-T), Lazanda (fentanyl citrate) nasal spray, Lescol (fluvastatin sodium), Lescol (fluvastatin sodium) capsules, Rx, Lescol XL (fluvastatin sodium) tablet, extended release, Letairis (ambrisentan), Leukine (sargramostim), Leukine (sargramostim), Levaquin, Levitra (vardenafil), Levo-T (levothyroxine sodium), Levoxyl, Lexapro (escitalopram oxalate), Lexiva (fosamprenavir calcium), Lexxel (enalapril maleate-felodipine ER), Lidoderm Patch (lidocaine patch 5%), Linzess (linaclotide), Lipitor (atorvastatin calcium), Lithobid (Lithium Carbonate), Livalo (pitavastatin), Lodine (etodolac), Lodine XL (etodolac), Lodine XL (etodolac), Lotemax, Lotrisone (clotrimazole/betamethasone diproprionate) lotion, Lotronex (alosetron HCL) Tablets, Lovenox (enoxaparin sodium) Injection, Lovenox (enoxaparin sodium) Injection, Lucentis (ranibizumab injection), Lucentis (ranibizumab), Lumigan (bimatoprost ophthalmic solution), Lunesta (eszopiclone), Lupron Depot (leuprolide acetate for depot suspension), Lupron Depot (leuprolide acetate for depot suspension), Lusedra (fospropofol disodium), Lustra, LUVOX (fluvoxamine maleate), Luxiq (betamethasone valerate) Foam, Lyrica (pregabalin), Lyrica (pregabalin), Lysteda (tranexamic acid), Macugen (pegaptanib), Malarone (atovaquone; proguanil hydrochloride) Tablet, Malarone (atovaquone; proguanil hydrochloride) Tablet, Marplan Tablets, Marqibo (vinCRIStine sulfate LIPOSOME injection), Mavik (trandolapril), Maxalt, Mentax (1% butenafine HCl cream), Mentax (1% butenafine HC1 cream), Mentax (1% butenafine HC1 cream), Menveo (meningitis vaccine), MERIDIA, Merrem I.V. (meropenem), Mesnex, Metadate CD, Metaglip (glipizide/metformin HCl), Metaprotereol Sulfate Inhalation Solution, 5%, Metozolv ODT (metoclopramide hydrochloride), MetroLotion, Mevacor (lovastatin) tablets, Miacalcin (calcitonin-salmon) Nasal Spray, Micardis (telmisartan), Micardis HCT (telmisartan and hydrochlorothiazide), Microzide (hydrochlorothiazide), Migranal, Minoxidil Topical Solution 2% for Women, Miraluma test, Mirapex, Mircera (methoxy polyethylene glycol-epoetin beta), Mircette, Mirena (levonorgestrel-releasing intrauterine system), Mobic (meloxicam) Tablets, Monistat 3 (miconazole nitrate), Monistat 3 (miconazole nitrate), Monurol, Moxatag (amoxicillin), Mozobil (plerixafor injection), Multaq (dronedarone), Muse, Mylotarg (gemtuzumab ozogamicin), Myobloc, Myozyme (alglucosidase alfa), Myrbetriq (mirabegron), Naglazyme (galsulfase), Naltrexone Hydrochloride Tablets, Namenda (memantine HCl), Naprelan (naproxen sodium), Nasacort AQ (triamcinolone acetonide) Nasal Spray, Nasacort AQ (triamcinolone acetonide) Nasal Spray, NasalCrom Nasal Spray, Nascobal Gel (Cyanocobalamin, USP), Nasonex Nasal Spray, Natazia (estradiol valerate+dienogest), Natazia (estradiol valerate and estradiol valerate/dienogest), Natrecor (nesiritide), Neulasta, Neumega, Neupogen, Neupro (Rotigotine Transdermal System), Neupro (rotigotine), Neurontin (gabapentin), Neurontin (gabapentin) oral solution, Neurontin (gabapentin) oral solution, Neutroval (tbo-filgrastim), Nexavar (sorafenib), Nexium (esomeprazole magnesium), Niaspan, NicoDerm CQ, Nicorette (nicotine polacrilex), Nicotrol nasal spray, Nicotrol transdermal patch, Nitrostat (nitroglycerin) Tablets, Nolvadex, NORCO tablets (Hydrocodone Bitartrate/Acetaminophen 10 mg/325 mg), Norditropin (somatropin (rDNA origin) for injection), Noritate, Normiflo, Norvir (ritonavir), Norvir (ritonavir), Novantrone (mitoxantrone hydrochloride), NovoLog (insulin aspart), Novolog Mix 70/30, Novothyrox (levothyroxine sodium), Noxafil (posaconazole), Nplate (romiplostim), Nucynta (tapentadol), Nuedexta (dextromethorphan hydrobromide and quinidine sulfate), Nulojix (belatacept), Nutropin (somatropin-rDNA origin), Nutropin (somatropin-rDNA origin), NuvaRing, Nuvigil (armodafinil), Ocuflox (ofloxacin opthalmic solution) 0.3%, OcuHist, Oleptro (trazodone hydrochloride), Omnicef, Omontys (peginesatide), Onfi (clobazam), Onglyza (saxagliptin), Onsolis (fentanyl buccal), Oral Cytovene, Oravig (miconazole), Orencia (abatacept), Orencia (abatacept), Orfadin (nitisinone), Ortho Evra, Ortho Tri-Cyclen Tablets (norgestimate/ethinyl estradiol), Ortho-Prefest, OsmoCyte Pillow Wound Dressing, Ovidrel (gonadotropin, chorionic human recombinant), Oxecta (oxycodone HCl), Oxycodone and Aspirin, Oxycodone with Acetaminophen 5 mg/325 mg, OxyContin (oxycodone HCl controlled-release), Oxytrol (oxybutynin transdermal system), Ozurdex (dexamethasone), Pancreaze (pancrelipase), Panretin Gel, Patanase (olopatadine hydrochloride), Paxil (paroxetine hydrochloride), Paxil CR (paroxetine hydrochloride), Paxil CR (paroxetine hydrochloride), Pediarix Vaccine, Peg-Intron (peginterferon alfa-2b), Pegasys (peginterferon alfa-2a), Pennsaid (diclofenac sodium topical solution), Pentoxifylline, Pepcid Complete, Periostat (doxycycline hyclate), Periostat (doxycycline hyclate), Perjeta (pertuzumab), PhosLo, Photodynamic Therapy, Photofrin, Picato (ingenol mebutate) gel, Pindolol, Plavix (clopidogrel bisulfate), Plavix (clopidogrel bisulfate), Plenaxis (abarelix for injectable suspension), Posicor, Potiga (ezogabine), Pradaxa (dabigatran etexilate mesylate), Pramipexole, Prandin, Pravachol (pravastatin sodium), Pravachol (pravastatin sodium), Precose (acarbose), Premarin (conjugated estrogens), Prempro, Prempro & Premphase (conjugated estrogens/medroxyprogesterone acetate tablets), PREVACID(R) (lansopraxole), PREVEN ; Emergency Contraceptive Kit, Prevnar 13 (Pneumococcal 13-valent Conjugate Vaccine), Prevpac, Prevpac, Prezista (darunavir), Priftin, Prilosec (omeprazole), Prilosec (omeprazole), Prilosec (omeprazole), Prilosec (omeprazole)/Biaxin (clarithromycin) Combination Therapy, Prinivil or Zestril (Lisinopril), ProAmatine (midodrine), Procanbid (procainamide hydrochloride extended-release tablets), Prochloroperazine, Prochlorperazine, Prograf, Proleukin, Prolia (denosumab), Promacta (eltrombopag), Prometrium, Prometrium, Propecia, Proscar, Protonix (pantoprazole sodium) Delayed Release Tablets, Protonix (pantoprazole sodium) Delayed-Release Tablets, Protonix (pantoprazole sodium) Intravenous Formulation, Protopic (tacrolimus) ointment, Provenge (sipuleucel-T), Proventil HFA Inhalation Aerosol, Prozac Weekly (fluoxetine HC1), Pulmozyme (dornase alfa), Pulmozyme (dornase alfa), Qnasl (beclomethasone dipropionate) nasal aerosol, Qsymia (phentermine+topiramate extended-release), Quadramet (Samarium Sm 153 Lexidronam Injection), Quillivant XR (methylphenidate hydrochloride), Quixin (levofloxacin), Qutenza (capsaicin), Qvar (beclomethasone dipropionate), Ranexa (ranolazine), Ranitidine Capsules, Ranitidine Tablets, Rapamune (sirolimus) oral solution, Rapamune (sirolimus) Tablets, Raplon, Raxar (grepafloxacin), Rayos (prednisone) delayed-release tablets, Rebetol (ribavirin), REBETRON™ Combination Therapy, Rebif (interferon beta-1a), Reclast (zoledronic acid), Reclast (zoledronic acid), Rectiv (nitroglycerin) ointment 0.4%, Redux (dexfenfluramine hydrochloride), Refludan, REGRANEX (becaplermin) Gel, Relenza, Relpax (eletriptan hydrobromide), Remeron (Mirtazapine), Remeron SolTab (mirtazapine), Remicade (infliximab), Remicade (infliximab), Reminyl (galantamine hydrobromide), Remodulin (treprostinil), Renagel (sevelamer hydrochloride), Renagel (sevelamer hydrochloride), RenaGelRenagel (sevelamer hydrochloride), Renova (tretinoin emollient cream), Renvela (sevelamer carbonate), ReoPro, REPRONEX(menotropins for injection, USP), Requip (ropinirole hydrochloride), Rescriptor Tablets (delavirdine mesylate tablets), Rescula (unoprostone isopropyl ophthalmic solution) 0.15%, RespiGam (Respiratory Syncitial Virus Immune Globulin Intravenous), Restasis (cyclosporine ophthalmic emulsion), Retavase (reteplase), Retin-A Micro (tretinoin gel) microsphere, 0.1%, Revlimid (lenalidomide), Reyataz (atazanavir sulfate), Rhinocort Aqua Nasal Spray, Rid Mousse, Rilutek (riluzole), Risperdal Oral Formulation, Ritalin LA (methylphenidate HCl), Rituxan, Rocephin, Rocephin, Rotarix (Rotavirus Vaccine, Live, Oral), Rotateq (rotavirus vaccine, live oral pentavalent), Rozerem (ramelteon), Rythmol, Sabril (vigabatrin), Saizen, Salagen Tablets, Samsca (tolvaptan), Sanctura (trospium chloride), Sancuso (granisetron), Saphris (asenapine), Savella (milnacipran hydrochloride), Sclerosol Intrapleural Aerosol, Seasonale, Lo Seasonale, Seasonique (ethinylestradiol+levonorgestrel), SecreFlo (secretin), Selegiline tablets, Self-examination breast pad, Selzentry (maraviroc), Sensipar (cinacalcet), Seprafilm, Serevent, Seroquel (R) (quetiapine fumarate) Tablets, Silenor (doxepin), Simponi (golimumab), Simulect, Singulair, Skelid (tiludronate disodium), Skin Exposure Reduction Paste Against Chemical Warfare Agents (SERPACWA), Sklice (ivermectin) lotion, Soliris (eculizumab), Soliris (eculizumab), Somatuline Depot (lanreotide acetate), Somavert (pegvisomant), Sonata, Spectracef, Spiriva HandiHaler (tiotropium bromide), SPORANOX (itraconazole), Sprix (ketorolac tromethamine), Sprycel (dasatinib), Stavzor (valproic acid delayed release), Stelara (ustekinumab), Stendra (avanafil), Stendra (avanafil), Stivarga (regorafenib), Strattera (atomoxetine HCl), Stribild (elvitegravir, cobicistat, emtricitabine, tenofovir disoproxil fumarate), Stromectol (ivermectin), Subsys (fentanyl sublingual spray), Subutex/Suboxone (buprenorphine/naloxone), Sulfamylon, Supartz, Supprelin LA (histrelin acetate), Surfaxin (lucinactant), Sustiva, Sutent (sunitinib malate), Sutent (sunitinib), Sylatron (peginterferon alfa-2b), Symlin (pramlintide), Synagis, Synercid I.V., Synthroid (levothyroxine sodium), Synvisc, Synvisc-One (Hylan GF 20), Tamiflu capsule, Tarceva (erlotinib, OSI 774), Tasigna (nilotinib hydrochloride monohydrate), Tasmar, Tavist (clemastine fumarate), Tavist (clemastine fumarate), Taxol, Taxotere (Docetaxel), Tazorac topical gel, Teczem (enalapril maleate/diltiazem malate), Teflaro (ceftaroline fosamil), Tegretol (carbamazepine), Tegretol XR (carbamazepine), Tekamlo (aliskiren+amlodipine), Tekturna (aliskiren), Temodar, Tequin, Testim, Testoderm TTS CIII, Teveten (eprosartan mesylate plus hydrochlorothiazide), Teveten (eprosartan mesylate), Thalomid, Tiazac (diltiazem hydrochloride), Tiazac (diltiazem hydrochloride), Tiazac (diltiazem hydrochloride), Tikosyn Capsules, Tilade (nedocromil sodium), Tilade (nedocromil sodium), Tilade (nedocromil sodium), Timentin, Timentin, Tindamax, tinidazole, Tobi, Tolmetin Sodium, Topamax (topiramate), Topamax (topiramate), Toprol-XL (metoprolol succinate), Torisel (temsirolimus), Toviaz (fesoterodine fumarate), Tracleer (bosentan), Tradjenta (linagliptin), Travatan (travoprost ophthalmic solution), Trazadone 150 mg, Treanda (bendamustine hydrochloride), Trelstar Depot (triptorelin pamoate), Trelstar LA (triptorelin pamoate), Tri-Nasal Spray (triamcinolone acetonide spray), Tribenzor (olmesartan medoxomil+amlodipine+hydrochlorothiazide), Tricor (fenofibrate), Tricor (fenofibrate), Trileptal (oxcarbazepine) Tablets, Trilipix (fenofibric acid), Tripedia (Diptheria and Tetanus Toxoids and Acellular Pertussis Vaccine Absorbed), Trisenox (arsenic trioxide), Trivagizole 3 (clotrimazole) Vaginal Cream, Trivora-21 and Trivora-28, Trizivir (abacavir sulfate; lamivudine; zidovudine AZT) Tablet, Trovan, Tudorza Pressair (aclidinium bromide inhalation powder), Twinrix, Tygacil (tigecycline), Tykerb (lapatinib), Tysabri (natalizumab), Tysabri (natalizumab), Tyvaso (treprostinil), Tyzeka (telbivudine), Uloric (febuxostat), Ultracet (acetaminophen and tramadol HCl), UltraJect, Ultresa (pancrelipase) delayed-release capsules, UroXatral (alfuzosin HCl extended-release tablets), Urso, UVADEX Sterile Solution, Valcyte (valganciclovir HCl), Valstar, Valtrex (valacyclovir HC1), Vancenase AQ 84 mcg Double Strength, Vanceril 84 mcg Double Strength (beclomethasone dipropionate, 84 mcg) Inhalation Aerosol, Vandetanib (vandetanib), Vaprisol (conivaptan), Vascepa (icosapent ethyl), Vectibix (panitumumab), Velcade (bortezomib), Veltin (clindamycin phosphate and tretinoin), Venofer (iron sucrose injection), Ventolin HFA (albuterol sulfate inhalation aerosol), Veramyst (fluticasone furoate), Verapamil, Verdeso (desonide), Veregen (kunecatechins), VERSED (midazolam HCl), Vesicare (solifenacin succinate), Vfend (voriconazole), Viadur (leuprolide acetate implant), Viagra, Vibativ (telavancin), Victoza (liraglutide), Victrelis (boceprevir), Vidaza (azacitidine), Videx (didanosine), Viibryd (vilazodone hydrochloride), Vimovo (naproxen+esomeprazole), Vimpat (lacosamide), Viokace (pancrelipase) tablets, Vioxx (rofecoxib), VIRACEPT (nelfinavir mesylate), Viramune (nevirapine), Viread (tenofovir disoproxil fumarate), Viread (tenofovir disoproxil fumarate), Viroptic, Visicol Tablet, Visipaque (iodixanol), Vistide (cidofovir), Vistide (cidofovir), Visudyne (verteporfin for injection), Vitrasert Implant, Vitravene Injection, Vivelle (estradiol transdermal system), Vivelle (estradiol transdermal system), Vivelle-Dot (estradiol transdermal system), Vivitrol (naltrexone for extended-release injectable suspension), Vivitrol (naltrexone for extended-release injectable suspension), Voraxaze (glucarpidase), Votrient (pazopanib), Votrient (pazopanib), Vpriv (velaglucerase alfa for injection), Vyvanse (Lisdexamfetamine Dimesylate), Warfarin Sodium tablets, Welchol (colesevelam hydrochloride), Western blot confirmatory device, Wilate (von Willebrand Factor/Coagulation Factor VIII Complex (Human), Xalkori (crizotinib), Xarelto (rivaroxaban), Xarelto (rivaroxaban), Xeloda, Xeloda, Xenazine (tetrabenazine), Xenical/Orlistat Capsules, Xeomin (incobotulinumtoxinA), Xgeva (denosumab), Xiaflex (collagenase clostridium histolyticum), Xifaxan (rifaximin), Xifaxan (rifaximin), Xigris (drotrecogin alfa [activated]), Xolair (omalizumab), Xopenex, Xtandi (enzalutamide), Xyrem (sodium oxybate), Xyzal (levocetirizine dihydrochloride), Yasmin (drospirenone/ethinyl estradiol), Yervoy (ipilimumab), ZADITOR, Zagam (sparfloxacin) tablets, Zaltrap (ziv-aflibercept), Zanaflex (tizanidine hydrochloride), Zantac 75 Efferdose, Zelboraf (vemurafenib), Zelnorm (tegaserod maleate) Tablets, Zelnorm (tegaserod maleate) Tablets, Zemaira (alphal-proteinase inhibitor), Zemplar, Zenapax, Zenpep (pancrelipase), Zerit (stavudine), Zerit (stavudine), Zevalin (ibritumomab tiuxetan), Zingo (lidocaine hydrochloride monohydrate), Zioptan (tafluprost ophthalmic solution), Ziprasidone (ziprasidone hydrochloride), Zipsor (diclofenac potassium), Zirgan (ganciclovir ophthalmic gel), Zithromax (azithromycin), Zocor, Zofran, Zofran, Zoladex (10.8 mg goserelin acetate implant), Zoloft (sertraline HCl), Zoloft (sertraline HCl), Zoloft (sertraline HCl), Zometa (zoledronic acid), Zometa (zoledronic acid), Zomig (zolmitriptan), Zomig (zolmitriptan), Zonegran (zonisamide) Capsules, Zortress (everolimus), Zosyn (sterile piperacillin sodium/tazobactam sodium), Zuplenz (ondansetron oral soluble film), Zyban Sustained-Release Tablets, Zyclara (imiquimod), Zyflo (Zileuton), Zymaxid (gatifloxacin ophthalmic solution), Zyprexa, Zyrtec (cetirizine HCl), Zytiga (abiraterone acetate), and mixtures or combination thereof.

### Controlled Pharmaceutical Materials

Suitable controlled pharmaceutical materials include, without limitation, 1-(1-phenylcyclohexyl)pyrrolidine (PCPy, PHP, rolicyclidine), 1 -(2-phenylethyl)-4-phenyl-4-acetoxypiperidine (PEPAP, synthetic heroin), 1-[1-(2-thienyl)cyclohexyl]piperidine (TCP, tenocyclidine), 1-[1-(2-thienyl)cyclohexyl]pyrrolidine (TCPy), 13β-ethyl-17-β-hydroxygon-4-en-3-one, 17α-methyl-3α,17β-dihydroxy-5α-androstane, 17α-methyl-3β,17β-dihydroxy-5α-androstane, 17α-methyl-3β,17β-dihydroxyandrost-4-ene, 17α-methyl-4-hydroxynandrolone (17α-methyl-4-hydroxy-17β-hydroxyestr-4-en-3-one), 17α-methyl-Δ1-dihydrotestosterone, (17α-methyl-4-hydroxy-17α-methyl-5α-androst-1-en-3-one) (17β,17α-methyl-1-testosterone), 19-Nor-4,9(10)-androstadienedione, 19-Nor-4-androstenediol (3β,17β-dihydroxyestr-4-ene; 3α,17β-dihydroxyestr-4-ene), 19-nor-4-androstenedione (estr-4-en-3,17-dione), 19-nor-5-androstenediol (3β,17β-dihydroxyestr-5-ene; 3α,17β-dihydroxyestr-5-ene), 19-nor-5-androstenedione (estr-5-en-3,17-dione), 1-androstenediol (3β,17β-dihydroxy-5α-androst-1-ene; 3α,17β-dihydroxy-5α-androst-1-ene), 1-androstenedione (5α-androst-1-en-3,17-dione), 1-methyl-4-phenyl-4-propionoxypiperidine (Mppp, synthetic heroin), 1-phenylcyclohexylamine (PCP precursor), 1-piperidinocyclohexanecarbonitrile (PCC, PCP precursor), 2,5-dimethoxy-4-ethylamphetamine (DOET), 2,5-dimethoxyamphetamine (DMA, 2,5-DMA), 2-(4-chloro-2,5-dimethoxyphenyl) ethanamine (2C-C), 2-(2,5-dimethoxy-4-methylphenyl) ethanamine (2C-D), 2-(2,5-dimethoxy-4-ethylphenyl) ethanamine (2C-E), 2-(2,5-dimethoxyphenyl) ethanamine (2C-H), 2-(4-iodo-2,5-dimethoxyphenyl) ethanamine (2C-I), 2-(2,5-dimethoxy-4-nitro-phenyl) ethanamine (2C-N), 2-(2,5-dimethoxy-4-(n)-propylphenyl ethanamine (2C-P), 2-(4-ethylthio-2,5-dimethoxyphenyl ethanamine (2C-T-2), 2-(4-isopropylthio)-2,5-dimethoxyphenyl ethanamine (2C-T-4), 2,5 -dimethoxy-4-(n)-propylthiophenethylamine (2C-T-7)3 ,4,5 -trimethoxyamphetamine (TMA), 3,4-methylenedioxyamphetamine (MDA, love drug), 3,4-methylenedioxymethamphetamine (MDMA, Ecstasy, XTC), 3,4-methylenedioxy-n-ethylamphetamine (N-ethyl MDA, MDE, MDEA), 3α,17β-dihydroxy-5α-androstane, 3β,17β-dihydroxy-5α-androstane, 3-methylfentanyl (China white, fentanyl), 3 -methylthiofentanyl (Chine white, fentanyl), 4-androstenediol (3β,17β-dihydroxy-androst-4-ene) (4-AD), 4-androstenedione (androst-4-en-3,17-dione), 4-anilino-n-phenethyl-4-piperidine (ANPP), 4-bromo-2,5-dimethoxyamphetamine (DOB, 4-bromo-DMA), 4-bromo-2,5-dimethoxyphenethylamine (2C-B, Nexus, has been sold as Ecstasy, i.e. MDMA), 4-dihydrotestosterone (17β-hydroxyandrostan-3-one) (Anabolex, Andractim, Pesomax, Stanolone), 4-hydroxy-19-nortestosterone (4,17β-dihydroxyestr-4-en-3-one), 4-hydroxytestosterone (4,17β-dihydroxyandrost-4-en-3 -one)4-methoxyamphetamine (PMA), 4-methyl-2,5-dimethoxyamphetamine (DOM, STP), 4-methylaminorex (cis isomer) (U4Euh, McN-422), 5-androstenediol (3β,17β-dihydroxy-androst-5-ene), 5-androstenedione (androst-5-en-3,17-dione), 1-(5-fluoro-pentyl)1H-indol-3 -yl] (2,2,3,3 -tetramethylcyclopropyl) methanone (5-flouro-UR-144 and XLR11), 5-methoxy-3,4-methylenedioxyamphetamine (MMDA), 5-methoxy-n,n-diisopropyltryptamine (5-MEO-DIPT), 5-methoxy-n-n-dimethyltryptamine (5-MEO-DMT), Acetorphine, Acetyl-α-methylfentanyl, Acetyldihydrocodeine (Acetylcodone), Acetylmethadol (Methadyl acetate), Alfentanil (Alfenta), Allylprodine, α-acetylmethadol except levo-αacetylmethadol, α-ethyltryptamine (ET, Trip), α-meprodine, α-methadol, α-methylfentanyl (China white, Fentanyl), α-methylthiofentanyl (China white, Fentanyl), α-methyltryptamine (AMT), α-prodine (Nisentil), alprazolam (Xanax), 1-(5-fluoropentyl)-3-(1-naphthoyl) indole (AM-2201), 1-(5-fluoropentyl)-3-(2-iodobenzoyl) indole (AM-694), aminorex, amobarbital (Amytal, Tuinal), amphetamine (Dexedrine, Adderall, Obetrol), Anabolic steroids, 5α-androstan-3,17-dione (Androstanedione), anileridine (Leritine), N-(1-adamantyl)-1-pentyl-1H-indazole-3-carboxamide (Apinaca and AKB48), aprobarbital (Alurate), barbital (Veronal, Plexonal, Barbitone), barbituric acid derivative and barbiturates, benzethidine, benzphetamine (Didrex, Inapetyl), benzylmorphine, β-acetylmethadol, β-hydroxy-3-methylfentanyl (China white, Fentanyl), β-hydroxyfentanyl (China white, Fentanyl), β-meprodine, β-methadol, β-prodine, bezitramide (Burgodin), 7α,17α-dimethyl-17β-hydroxyandrost-4-en-3-one (Bolasterone), 17β-hydroxyandrost-1,4-diene-3-one (Boldenone Equipoise, Parenabol, Vebonol, dehydrotestosterone), boldione, bromazepam (Lexotan, Lexatin, Lexotanil), bufotenine (Mappine, N,N-dimethylserotonin), buprenorphine (Buprenex, Temgesic, Subutex, Suboxone), butabarbital (secbutabarbital, Butisol, Butibel), butalbital (Fiorinal, butalbital with aspirin), butobarbital (Butethal, Soneryl (UK)), butorphanol (Stadol, Stadol Ns, Torbugesic, Torbutrol), 7β,17α-dimethyl-17β-hydroxyandrost-4-en-3-one (Calusterone Methosarb), camazepam (Albego, Limpidon, Paxor), carfentanil (Wildnil), carisoprodol (Soma), cathine, cathinone, chloral βine (Beta chlor), chloral hydrate (Noctec), chlordiazepoxide (Librium, Libritabs, Limbitrol, SK-Lygen), chlorhexadol (Mechloral, Mecoral, Medodorm, Chloralodol), chlorphentermine (Pre-sate, Lucofen, Apsedon, Desopimon), clobazam (Urbadan, Urbanyl), clonazepam (Klonopin, Clonopin), clonitazene, clorazepate (Tranxene), clortermine (Voranil), 4-chloro-17β-hydroxyandrost-4-en-3 -one (Clostebol, Alfa-trofodermin, Clostene, 4-chlorotestosterone), clotiazepam (Trecalmo, Rize, Clozan, Veratran), cloxazolam (Akton, Lubalix, Olcadil, Sepazon), coca leaves, cocaine (Methyl benzoylecgonine, crack), codeine (Morphine methyl ester, methyl morphine), codeine & isoquinoline alkaloid, codeine methylbromide, codeine-n-oxide, 5-(1,1-dimethylheptyl)-2-(1R,3S)-3-hydroxycyclohexyl-phenol (Cp-47497), 5-(1,1-dimethyloctyl)-2-(1R,3S)3-hydroxycyclohexyl-phenol (CP-47497 C8 Homologue), cyprenorphine, 4-chloro-17β-hydroxy-17α-methylandrost-1,4-dien-3-one (Dehydrochloromethyltestosterone Oral-Turinabol), delorazepam, 17β-hydroxy-5α-androst-1-en-3-one (Δ1-dihydrotestosterone), desomorphine, desoxymethyltestosterone, dexfenfluramine (Redux), dextromoramide (Palfium, Jetrium, Narcolo), dextropropoxyphene (Darvon, Propoxyphene, Darvocet, Propacet), dextropropoxyphene (Propoxyphene), diampromide, diazepam (Valium, Diastat), dichloralphenazone (Midrin, dichloralantipyrine), diethylpropion (Tenuate, Tepanil), diethylthiambutene, diethyltryptamine (DET), difenoxin (Lyspafen), difenoxin (Motofen), dihydrocodeine (Didrate, parzone), dihydrocodeine (Synalgos-DC, Compal, Cophene-S), dihydroetorphine (DHE), dihydromorphine, dimenoxadol, dimepheptanol, dimethylthiambutene, dimethyltryptamine (DMT), dioxaphetyl butyrate, diphenoxylate (Lomotil, Logen), dipipanone (Dipipan, phenylpiperone hcl, Diconal, Wellconal), dronabinol (Marinol), 17β-hydroxy-2α-methyl-5α-androstan-3-one (Drostanolone, Drolban, Masterid, Permastril)drotebanol (Metebanyl, Oxymethebanol), ecgonine (Cocaine precursor, in Coca leaves), embutramide (Tributane), estazolam (ProSom, Domnamid, Eurodin, Nuctalon), ethchlorvynol, (Placidyl), ethinamate (Valmid, Valamin), ethyl loflazepate, 17α-ethyl-17β-hydroxyestr-4-ene (Ethylestrenol, Maxibolin, Orabolin, Durabolin-O, Duraboral), ethylmethylthiambutene, ethylmorphine (Dionin), etonitazene, etorphine, etorphine HCl (M 99), etoxeridine, ezogabine (Potiga), fencamfamin (Reactivan), fenethylline (Captagon, Amfetyline, Ethyltheophylline Amphetamine), fenfluramine (Pondimin, Ponderal), fenproporex (Gacilin, Solvolip), fentanyl (Duragesic, Oralet, Actiq, Sublimaze, Innovar), fludiazepam, flunitrazepam (Rohypnol, Narcozep, Darkene, Roipnol), 9-fluoro-17α-methyl-11β,17β-dihydroxyandrost-4-en-3-one (drostanolone Anadroid-F, Halotestin, Ora-Testryl), flurazepam (Dalmane), 2-formyl-17α-methyl-11α, 17β-dihydroxyandrost-1,4-dien-3-one (Formebolone, Esiclene, Hubernol), fospropofol (Lusedra), 17α-methyl-17β-hydroxyandrostano[2,3-C]-furazan (Furazabol, Frazalon, Miotolon, Qu Zhi Shu)furethidine, γ-hydroxybutyric ccid (GHB, Gamma Hydroxybutyrate, Sodium Oxybate, Xyremglutethimide (Doriden, Dorimide), halazepam (Paxipam), haloxazolam, heroin (Diacetylmorphine, diamorphine), hydrocodone (dihydrocodeinone,m Dihydrocodeinone+papaverine or noscapine, Lorcet, Lortab, Vicodin, Vicoprofen, Tussionex, Norco), hydromorphinol, hydromorphone (Dilaudid, dihydromorphinone), hydroxypethidine, ibogaine, isomethadone (Isoamidone), 1-pentyl-3-(1-naphthoyl)indole (JWH-018 and AM-678), 1-hexyl-3-(1-naphthoyl)indole (JWH-019), 1-butyl-3-(1-naphthoyl)indole (JWH-073), 1-pentyl-3-(1-(4-methoxynaphthoyl) indole (JWH-081), 1-pentyl-3-(4-methyl-1-naphthoyl) indole (JWH-122), 1-[2-(4-morpholinyl)ethyl]-3-(1-naphthoyl)indole (JWH-200), 1-pentyl-3-(2-chlorophenylacetyl) indole (JWH-203), 1-pentyl-3-(2-methoxyphenylacetyl) indole (JWH-250), 1-pentyl-3-(4-chloro-1-naphthoyl) indole (JWH-398), ketamine (Ketaset, Ketalar, Special K,K), ketazolam (Anxon, Loftran, Solatran, Contamex), ketobemidone (Cliradon), lacosamide (Vimpat), levo-α-acetylmethadol (LAAM, long acting methadone, levomethadyl acetate), levomethorphan, levomoramide, levophenacylmorphan, levorphanol (Levo-Dromoran), lisdexamfetamine (Vyvanse), loprazolam, lorazepam (Ativan), lorcaserin (Belviq), lormetazepam (Noctamid), lysergic acid (LSD precursor), lysergic acid amide (LSD precursor), lysergic acid diethylamide (LSD, lysergide), marihuana (Cannabis, marijuana), mazindol (Sanorex, Mazanor), 3,4-Methylenedioxypyrovalerone (MDPV), mebutamate (Capla), mcloqualone (Nubarene), medazepam (Nobrium), mefenorex (Anorexic, Amexate, Doracil, Pondinil), meperidine (Demerol, Mepergan, pethidine), meperidine intermediate-A (Meperidine precursor), meperidine intermediate-B (Meperidine precursor, normeperidine), meperidine intermediate-C (Meperidine precursor), 4-methyl-N-methylcathinone (Mephedrone), meprobamate (Miltown, Equanil, Micrainin, Equagesic, Meprospanmescaline 17α-methyl-17β-hydroxy-5α-androstan-3-one (Mestanolone, Assimil, Ermalone, Methybol, Tantarone), 1α-methyl-17β-hydroxy-5α-androstan-3-one (Mesterolone, Androviron, Proviron, Testiwop), metazocine, methadone (Dolophine, Methadose, Amidone), methamphetamine (Desoxyn, D-desoxyephedrine, ICE, Crank, Speed), 17α-methyl-17β-hydroxyandrost-1,4-diene-3-one (Methandienone, Dianabol, Metabolina, Nerobol, Perbolin), 17α-methyl-3β,17β-dihydroxyandrost-5-ene (Methandriol, Sinesex, Stenediol, Troformone), methaqualone (Quaalude, Parest, Somnafac, Opitimil, Mandrax), 2α,17α-dimethyl-5α-androstan-17β-ol-3-one (Methasterone), methcathinone (N-Methylcathinone, “cat”), 1-methyl-17β-hydroxy-5α-androst-1-en-3-one (Methenolone, Primobolan, Primobolan Depot, Primobolan S), methohexital (Brevital), methyldesorphine, 17α-methyl-17β-hydroxyestr-4,9(10)-dien-3-one (Methyldienolone), methyldihydromorphine, 3,4-methylenedioxy-N-methylcathinone (Methylone), methylphenidate (Concerta, Ritalin, Methylin), methylphenobarbital (mephobarbital) (Mebaral, mephobarbital), 17α-methyl-17β-hydroxyandrost-4-n-3-one (Methyltestosterone, Android, Oreton, Testred, Virilon), 17α-methyl-17β-hydroxyestr-4,9,11-trien-3-one (Methyltrienolone, Metribolone), methyprylon (Noludar), metopon, 7α,17α-dimethyl-17β-hydroxyestr-4-en-3-one (Mibolerone, Cheque, Matenon), midazolam (Versed), modafinil (Provigil), moramide-intermediate, morpheridine, morphine (MS Contin, Roxanol, Oramorph, RMS, MSIR), morphine methylbromide, morphine methylsulfonate, morphine-N-oxide, myrophine, N,N-dimethylamphetamine, nabilone (Cesamet), nalorphine (Nalline), 17β-hydroxyestr-4-en-3-one (Nandrolone, Deca-Durabolin, Durabolin, Durabolin-50), N-benzylpiperazine (BZP, 1-benzylpiperazine), N-ethyl-1-phenylcyclohexylamine (PCE), N-ethyl-3-piperidyl benzilate (JB 323), N-ethylamphetamine (NEA), N-hydroxy-3,4-methylenedioxyamphetamine (N-hydroxy MDA), nicocodeine, nicomorphine (Vilan), nimetazepam (Erimin), nitrazepam (Mogadon), N-methyl-3-piperidyl benzilate (JB 336), noracymethadol, 13β,17α-diethyl-17β-hydroxygon-4-en-3-one (Norbolethone Genabol), 4-chloro-17β-hydroxyestr-4-en-3-one (Norclostebol, Anabol-4-19, Lentabol), nordiazepam (Nordazepam, Demadar, Madar), 17α-ethyl-17β-hydroxyestr-4-en-3-one (Norethandrolone, Nilevar, Pronabol, Solevar), norlevorphanol, normethadone (Phenyldimazone), 17α-methyl-17β-hydroxyestr-4-en-3-one (Normethandrolone, Lutenin, Matronal, Orgasteron), normorphine, norpipanone, opium (Paregoric, Papaver somniferum, Parepectolin, Kapectolin PG, Kaolin Pectin P.G., Laudanum), oripavine, 17α-methyl-17β-hydroxy-2-oxa-5α-androstan-3-one (Oxandrolone, Anavar, Lonavar, Oxandrin, Provitar, Vasorome), oxazepam (Serax, Serenid-D), oxazolam (Serenal, Convertal), oxycodone (OxyContin, Percocet, Endocet, Roxicodone, Roxicet), 17α-methyl-4,17β-dihydroxyandrost-4-en-3-one (Oxymesterone Anamidol, Balnimax, Oranabol, Oranabol l0), 17α-methyl-2-hydroxymethylene-17β-hydroxy-5α-androstan-3-one (Oxymetholone, Anadrol-50, Adroyd, Anapolon, Anasteron, Pardroyd), oxymorphone (Numorphan), para-Fluorofentanyl (China White, fentanyl), parahexyl (Synhexyl), paraldehyde (Paral), pemoline (Cylert), pentazocine (Talwin, Talwin NX, Talacen, Talwin Compound), pentobarbital (Nembutal, FP-3, WANS), Petrichloral (Pentaerythritol chloral, Periclor), peyote (Cactus which contains mescaline), phenadoxone, phenampromide, phenazocine (Narphen, Prinadol), phencyclidine (PCP, Sernylan), phendimetrazine (Plegine, Prelu-2, Bontril, Melfiat, Statobex), phenmetrazine (Preludin), phenobarbital (Luminal, Donnatal, Bellergal-S), phenomorphan, phenoperidine (Operidine, Lealgin), phentermine (Ionamin, Fastin, Adipex-P, Obe-Nix, Zantryl), phenylacetone (P2P, phenyl-2-propanone, benzyl methyl ketone), pholcodine (Copholco, Adaphol, Codisol, Lantuss, Pholcolin), piminodine, pinazepam (Domar), pipradrol (Detaril, Stimolag Fortis), piritramide (Piridolan), prazepam (Centrax), pregabalin (Lyrica), proheptazine, properidine, propiram (Algeril), 17β-hydroxy-5α-androstano[3,2-c]pyrazole (Prostanozol), psilocybin, psilocyn (Psilocin), pyrovalerone (Centroton, Thymergix), quazepam (Doral), racemethorphan, racemoramide, racemorphan (Dromoran), remifentanil (Ultiva), secobarbital (Seconal, Tuinal), sibutramine (Meridia), 1-dimethylamino-1,2-diphenylethane (SPA Lefetamine), 1-cyclohexylethyl-3-(2-methoxyphenylacetyl) indole (SR-18, RCS-8), 1-pentyl-3-[(4-methoxy)-benzoyl] indole (SR-19, RCS-4), 17α-methyl-17β-hydroxy-5α-androst-2-eno[3,2-C]-pyrazole (Stanozolol, Winstrol, Winstrol-V), 17β-hydroxy-2-methyl-5α-androst-1-en-3-one (Stenbolone), sufentanil (Sufenta), sulfondiethylmethane, sulfonethylmethane, sulfonmethane, talbutal (Lotusate), tapentadol, temazepam (Restoril), 13-hydroxy-3-oxo-13,17-secoandrosta-1,4-dien-17-oic acid lactone (Testolactone, Teolit, Teslac), 17β-hydroxyandrost-4-en-3-one (Testosterone, Android-T, Androlan, Depotest, Delatestryl), tetrahydrocannabinols (THC, Delta-8 THC, Delta-9 THC, dronabinol), 13β,17α-diethyl-17β-hydroxygon-4,9,11-trien-3-one (Tetrahydrogestrinone, THG), tetrazepam (Myolastan, Musaril), Thebacon (Acetylhydrocodone, Acedicon, Thebacetyl), thebaine, thiamylal (Surital), thiofentanyl (Chine white, fentanyl), thiopental (Pentothal), tiletamine & zolazepam Combination Product (Telazol), tilidine (Tilidate, Valoron, Kitadol, Lak, Tilsa), 17β-hydroxyestr-4,9,11-trien-3-one (Trenbolone, Finaplix-S, Finajet, Parabolan), triazolam (Halcion), trimeperidine (Promedolum), 1-pentyl-1H-indol-3 -yl)(2,2,3,3-tetramethylcyclopropyl) methanone (UR-144), vinbarbital (Delvinal, vinbarbitone), zaleplon (Sonata), zolpidem (Ambien, Ivadal, Stilnoct, Stilnox), zopiclone (Lunesta), and mixtures or combinations thereof.

### Other Materials

Suitable used or waste materials include, without limitation, any used or waste material. Exemplary examples of used or waste materials include, without limitation, used or waste industrial materials, used or waste municipal materials, used or waste healthcare materials, used or waste medical materials, used or waste agricultural materials, used or waste biomass materials, used or waste electronic materials, used or waste metal materials, or mixtures or combinations thereof. Used or waste healthcare and used or waste medical waste can include medical waste, generated by people, doctors, doctor offices, clinics, emergency clinics, hospitals, dentists, dentistry clinics and hospitals, veterinarians, veterinary clinics and hospitals, farms, farmer, ranches, ranchers, or producers of used or waste material and/or other facilities that produce used or waste material. These used or waste materials are generally complex mixtures of components including, without limitation, pulp materials, fiber materials, fabric materials, polymer materials, metal materials, ceramic materials, ash materials, other materials and/or mixtures or combinations thereof.

Pulp materials suitable for use herein include, without limitation, wood, wood chips, sawdust, paper, cardboard, and/or mixtures or combinations thereof.

Fiber materials suitable for use herein include, without limitation, natural fibers, synthetic fibers, or the like and mixtures or combinations thereof. Exemplary fibers include, without limitation, inorganic fibers, carbon fibers, boron-nitride fibers, organic fibers, ceramic fibers, glass fibers, any other fibrous material and mixtures or combinations thereof.

Fabric materials suitable for use herein include, without limitation, any natural or synthetic fabric and mixtures or combinations thereof. Exemplary examples include, without limitation, cotton, wool and other fabrics made from animals or plants, RAYON, DACRON, fabric made of polyamides, or any other fabric or mixtures or combinations thereof.

The metal or metallic materials include, without limitation, any metal or metal alloy including a metal from the periodic table of elements. Exemplary examples include, alkali metals (Group 1 metals), alkaline earth metals (Group 2 metals), transition metals (Group 3-12 metals), Lanthanide metals, Actinide metals, post-transition metals, metalloids, or mixtures or combinations thereof. Certain metals and metalloids may be removed prior to use depending on the use to which the burnable fuels is put. The metals can be in any form include fibers, pieces, devices including metals, etc. and mixtures or combinations thereof. Exemplary examples include waste electronic devices. Of course, it should be recognized to one of ordinary skill in the art, that certain metals and metal alloys either pose a health or environmental concerns or issue or process concern or issues. Exemplary examples of such metals or metal alloys would include mercury, cadmium, lead, and thallium and radioactive elements and/or isotopes.

Ceramic materials suitable for use herein include, without limitation, any ceramic material or ceramic containing material or mixtures or combinations thereof. Exemplary examples include, without limitation, electronic substrates, glass, dishes, clay pots, any other object that contain a ceramic material, and mixtures or combinations thereof

The polymer materials suitable for use herein include, without limitation, plastics, thermoplastics, elastomers, thermoplastic elastomers, resins, and other polymer or polymeric materials and/or mixtures or combinations thereof.

Agricultural materials suitable for use herein include, without limitation, any agricultural waste, any agricultural packaging material and mixtures or combinations thereof.

Biomass materials suitable for use herein include, without limitation, any plant matter that is left over after processing to produce an end product such as sugar cane and sugar beet processing, and mixtures or combination thereof

Other materials can include, without limitation, chemicals, ash, pharmaceuticals (e.g., unused pharmaceuticals, expired pharmaceuticals, or any other pharmaceutical compostions), ceramics, binding agents, composites materials of one or more of the components set forth above, any other materials and/or mixtures or combinations thereof. The inventors have also found that ash derived from incinerating certain used or waste materials, where the ash still has material or fuel value can be added to the material to change or augment a compositional makeup of the fuel.

In all of the mixtures, polymer materials from other sources of waste, unused and/or virgin polymer materials can be added as binding agents to the material before burning or before forming the material into a desired compact shape followed by combustion of the fuel. The inventors believe that polymer materials act as binders in the shaping process, e.g., pelletizing, and help to increase the combustible nature of the resulting fuel.

The used or waste material can include any mixture or combination of any of the above identified materials.

Suitable virgin and/or unused materials can be any material that has not been used and is added to the input material to change a property of the resulting fuel including altering a fuel value of the material, altering an ash composition of the material, expired pharmaceuticals, altering a fluidity of the material, altering a bulk density of the material, altering the cohesiveness of the material, altering the wettability of the material, or altering other properties or two or more properties of the material or mixtures or combinations thereof

Suitable container or packaging include, without limitation, boxes, barrels, sacks, other containers, or mixtures or combinations thereof

Suitable disinfecting and/or partially or completely sterilizing equipment include, without limitation, any equipment that can disinfect, and/or partially or completely sterilize used or waste material such as autoclaves including those manufactured by OnSite Sterilization, LLC of Pottstown, Pa., chemical treatments, thermal treatments, radiant treatments, radiological treatments, or any combination thereof.

Suitable pre-treating equipment includes, without limitation, heating units, vaporizing units, pyrolyzing units, washing units (water or solvent), cracking units, cooling units, magnetic separation units, electrolysis units, air floatation units, screening units, segregating units, sedimentation units, fracturing units, shredding units, ultrasonic units, disinfecting units, sterilizing units, chemical treating units, neutralizing units, quality control units, cryogenic units, condensing units, polymerizing units, and mixtures or combinations thereof.

Suitable sizing and homogenizing equipment includes, without limitation, shredders, grinders, choppers, hammer mills, ball mills, or any other equipment used to reduce the physical size of a complex material or any combination of these equipment in series, parallel or a combination thereof. Shedders including those manufactured by SSI Shredding Systems, Inc. of Wilsonville, Oreg.

Suitable shaping equipment includes, without limitation, pelletizers such as those manufactured by Roskamp Champion of Waterloo, Iowa or California Pellet Mill Co. of Crawfordsville, Ind., extruders, other compressing forming equipment or any combination thereof.

Suitable incinerator equipment includes, without limitation, any incinerator equipment, pyrolysis treatments, plasma treatments, or other treatments that can burn or combust a used or waste material to an ash, having a given un-used fuel value from 0 to some finite value. Exemplary examples include CONSUIMAT® Incinerators manufactured by Consutech Systems, LLC (CONSUMAT is a registered trademark of Consutech Systems, LLC).

Suitable fuel utilization equipment include, without limitation, cement plants, lime plants, brick plants, power plants, municipal incinerators for steam generation, or any other facility that burns fuel and converts heat derived from the burning of the fuel into a usable form of energy or for use of the heat and ash to make an end product or any combination thereof.

For embodiments of the fuels derived from the present invention that are designed to be formed or shaped into a consolidated structure such as a pellet, the used or waste material compositions include an effective amount of binding agents, sufficient to permit the shaping to maintain its final shape. The binding agents are selected from the group consisting of polymer materials or other materials that have a melting or softening temperature between about 40° C. and about 150° C. In certain embodiments, the binding agents are polymer components in used or waste material having a melting or softening temperature between about 40° C. and about 150° C. Exemplary examples of such polymeric materials include, without limitation, modified cellulose, fabrics, plastics, thermoplastics, thermoplastic elastomers, elastomers, fiber enforced resins, metalized or metal coated plastics or polymers, or other polymeric materials and mixtures or combinations thereof. Exemplary plastics and thermoplastics include, without limitation, polyolefins, fluorinated polyolefins, chlorinated polyolefins, polyurethanes, polyalkyleneoxides, polyethers, polyesters, polyamides, polyimides, polycarbonates, epoxy resins, phenolic resins, alkylide resins, polyacrylates, polylactic acid, polyglycolic acid, other biocompatible polymers, and mixtures or combinations thereof. In other embodiments, the bonding agents can include ash alone or in combination with other binding agents. In other embodiments, binding agents can be added to the material to enhance or improve consolidation, to change or alter final ash composition, to reduce or increase metal content, to change or alter consolidated particle properties, to modify or change final particle appearance, or to enhance, improve, alter or change any other final property of the consolidated products of this invention. In specific, materials can be added to the burnable fuel as is, before or after sizing or sizing and shaping to adjust a heat content and/or ash composition of the burnable fuel regardless of its nature or shape.

Suitable transportation subsystems include, without limitation, common carriers, contract carriers, medical waste pick-up service companies, hazardous waste pick-up service companies, or mixtures and combinations thereof. Exemplary examples of common carriers include, without limitation, United States Postal Services, UPS, FedEx, DHL, Lone Star, or any other shipping organization. Exemplary examples of contract carriers include, without limitation, Xpress Global Systems of San Diego, Calif.; USF of San Diego, Calif.; GI Trucking Company of Chula Vista, Calif.; Yellow Transportation of San Diego, Calif.; Con-Way of Chula Vista, Calif.; Roadway Express of Santee, Calif.; Exel of Westerville, Ohio; UPS Inc. of Alpharetta, Ga.; Ceva Logistics of Houston, Tex.; Ryder System Inc. Of Miami, Fla.; C.H. Robinson Worldwide of Eden Prairie, Minn.; Genco ATC of Pittsburgh, Pa.; DB Schenker USA of Freeport, N.Y.; Neovia Logistics of Downers Grove, Ill.; J.B. Hunt Transport Services of Lowell, Ark.; Kuehne+Nagel Inc. of Jersey City, N.J.; Swift Transportation Co. of Phoenix, Ariz.; Werner Global Logistics of Omaha, Nebr.; NFI of Cherry Hill, N.J.; Expeditors International of Washington of Seattle, Wash.; APL Logistics of Scottsdale, Ariz.; Schneider National Inc. of Green Bay, Wis.; Penske Truck Leasing Co. of Reading, Pa.; OHL of Brentwood, Tenn.; New Breed Logistics of High Point, N.C.; Ingram Micro Logistics of Santa Ana, Calif.; Menlo Worldwide Logistics of San Mateo, Calif.; UTi Worldwide of Long Beach, Calif.; Ruan Transportation Management Systems of Des Moines, Iowa; Jacobson Companies of Des Moines, Iowa; Panalpina Inc. of Morristown, NJ; Kenco Group of Chattanooga, Tenn.; Greatwide Logistics Services of Dallas, Tex.; U.S. Xpress Enterprises of Chattanooga, Tenn.; Fidelitone Logistics of Wauconda, Ill.; 3PD Inc. of Atlanta, Ga.; Hub Group of Downers Grove, Ill.; Cardinal Logistics Management of Concord, N.C.; DSC Logistics of Des Plaines, Ill.; VersaCold Logistics Services of Vancouver, British Columbia, Canada; Linc Logistics Co. of Warren, Mich.; FedEx of Menphis, Tenn.; ModusLink Global Solutions of Waltham, Mass.; Saddle Creek Logistics Services of Lakeland, Fla.; BDP International of Philadelphia, Pa.; Agility Logistics of Irvine, Calif.; Total Quality Logistics of Cincinnati, Ohio; Landstar System of Jacksonville, Fla.; England Logistics of Salt Lake City, Utah; Damco International of Madison, N.J.; Pacer International of Dublin, Ohio; Averitt Express of Cookeville, Tenn.; SCI Logistics of Toronto, Canada; Warehouse Specialities Inc. of Appleton, Wis.; Yusen Logistics (Americas) of Secaucus, N.J.; MIQ Logistics of Overland Park, Kans.; Kane Is Able Inc. of Scranton, Pa.; or any other commercial carrier. Exemplary examples of medical waste pick-up service companies include, without limitation, Stericycle, Inc., Daniels Sharpsmart, Daniels International, Waste Management, any other medical waste pick-up service company, or mixtures and combinations thereof. Exemplary examples of hazardous waste pick-up service companies include, without limitation, Veolia Environmental Services, Clean Harbors, Heritage Environmental Services, any other hazardous waste pick-up service company, or mixtures and combinations thereof.

### Compositional Ranges of the Source Pharmaceutical Material

Embodiments of this invention include source waste pharmaceutical materials including one or a plurality of unused pharmaceutical containing materials including over-the-counter (OTC) pharmaceuticals, prescription pharmaceutical containing materials and controlled pharmaceutical containing materials. The source waste pharmaceutical materials may also include used or waste materials including used or waste healthcare materials, used or waste medical materials, metal materials, or mixtures or combinations thereof. The source waste pharmaceutical materials generally includes both combustible materials and non-combustible materials. Exemplary examples of both combustible and non-combustible materials include, without limitation, over-the-counter (OTC) pharmaceuticals, prescription pharmaceuticals, controlled pharmaceuticals, pulp materials, fiber materials, fabric materials, polymer materials, metal materials, ceramic materials, ash materials, and/or other waste materials. Depending on their use, the source waste pharmaceutical materials of this invention may be tailored to meet any desired need. By controlling the relative amount of combustible materials and non-combustible materials in the source containing materials pharmaceutical material, properties of the fuel may be adjusted to desired fuel values. Such fuel properties include, without, limitation, a fuel value, a burn rate, a flow rate, an ash composition, an ash weight, by-product compositions and types, metal concentrations, chlorine and/or bromine concentrations, or any mixture or combination of properties. Other materials may be present in the source waste pharmaceutical materials to tailor a composition of the ash being produced as the fuel is being burned. The fuel value may be adjusted up or down by changing the mix of combustible materials present and may be augmented further by adding a conventional fuel to the waste materials or treated materials before or simultaneous with burning of the burnable fuels of this invention. Combustible materials include over-the-counter (OTC) pharmaceuticals, prescription pharmaceuticals, controlled pharmaceuticals, pulp materials, fiber materials, fabric materials, polymer materials, binding agents, conventional fuels, other combustible materials, metal materials (converted to oxides during combustion), or mixtures or combinations thereof. Non-combustible materials include oxides such as silica, alumina, titania, etc.; sand; volcanic ash; dirt; ceramics; glasses; other inorganic materials, or mixtures and combinations thereof.

In certain embodiments of this invention, the waste pharmaceutical materials have a composition including from about 50 wt. % to about 100 wt. % of combustible materials and from about 50 wt. % to about 0 wt. % of non-combustible materials. In other embodiments, the source waste pharmaceutical material has a composition including from about 60 wt. % to about 100 wt. % of combustible materials and from about 40 wt. % to about 0 wt. % of non-combustible materials. In other embodiments, the source waste pharmaceutical material has a composition including from about 70 wt. % to about 100 wt. % of combustible materials and from about 30 wt. % to about 0 wt. % of non-combustible materials. In other embodiments, the source waste pharmaceutical material has a composition including from about 80 wt. % to about 100 wt. % of combustible materials and from about 20 wt. % to about 0 wt. % of non-combustible materials.

In certain embodiments of this invention, the waste pharmaceutical material had a composition including 50 wt. % to about 100 wt. % of unused pharmaceuticals including over-the-counter (OTC) pharmaceuticals, prescription pharmaceuticals and controlled pharmaceuticals, from about 50 wt. % to about 0 wt. % of pulp materials, from about 50 wt. % to about 0 wt. % of fiber materials, from about 50 wt. % to about 0 wt. % of fabric materials, from about 50 wt. % to about 0 wt. % polymer materials, and from about 10 wt. % to about 0 wt. % of metal materials. The waste pharmaceutical material may also include from about 50 wt. % to about 0 wt. % of binding agents, from about 50 wt. % to about 0 wt. % of conventional fuels, and from about 50 wt. % to about 0 wt. % of ash materials. The makeup of the waste pharmaceutical materials may sum to an amount greater than 100 wt. %, making the component makeup relative instead of absolute. However, based on a given relative component makeup, the absolute component makeup may be determined. The augmenting materials are added to the source pharmaceutical material to adjust the makeup of the materials to better formulate the materials for use as a fuel or a landfill material.

In certain embodiments of this invention, the waste pharmaceutical material has a composition including 50 wt. % to about 100 wt. % of unused pharmaceuticals including over-the-counter (OTC) pharmaceuticals, prescription pharmaceuticals and controlled pharmaceuticals, from about 50 wt. % to about 0 wt. % of pulp materials, from about 25 wt. % to about 0 wt. % of fiber materials, from about 25 wt. % to about 0 wt. % of fabric materials, from about 50 wt. % to about 10 wt. % polymer materials, and from about 10 wt. % to about 0 wt. % of metal materials. The waste pharmaceutical material may also include from about 25 wt. % to about 0 wt. % of binding agents, from about 25 wt. % to about 0 wt. % of conventional fuels, and from about 25 wt. % to about 0 wt. % of ash materials. The makeup of the source waste or waste pharmaceutical material may sum to an amount greater than 100 wt. %, making the component makeup relative instead of absolute. However, based on a given relative component makeup, the absolute component makeup may be determined. The augmenting materials are added to the waste pharmaceutical material to adjust the makeup of the materials to better formulate the materials for use as a fuel or a landfill material.

In certain embodiments of this invention, the source waste pharmaceutical material or waste pharmaceutical material has a composition including 50 wt. % to about 100 wt. % of unused pharmaceuticals including over-the-counter (OTC) pharmaceuticals, prescription pharmaceuticals and controlled pharmaceuticals, from about 50 wt. % to about 25 wt. % of pulp materials, from about 15 wt. % to about 0 wt. % of fiber materials, from about 15 wt. % to about 0 wt. % of fabric materials, from about 50 wt. % to about 25 wt. % polymer materials, and from about 7.5 wt. % to about 0 wt. % of metal materials. The waste pharmaceutical material or waste pharmaceutical material may also include from about 15 wt. % to about 0 wt. % of binding agents, from about 15 wt. % to about 0 wt. % of conventional fuels, and from about 15 wt. % to about 0 wt. % of ash materials. The makeup of the source pharmaceutical material may sum to an amount greater than 100 wt. %, making the component makeup relative instead of absolute. However, based on a given relative component makeup, the absolute component makeup may be determined. The augmenting materials are added to the source pharmaceutical material to adjust the makeup of the materials to better formulate the materials for use as a fuel or a landfill material.

In certain embodiments of this invention, the waste pharmaceutical material or waste pharmaceutical material has a composition including 60 wt. % to about 100 wt. % of unused pharmaceuticals including over-the-counter (OTC) pharmaceuticals, prescription pharmaceuticals and controlled pharmaceuticals, from about 50 wt. % to about 25 wt. % of pulp materials, from about 5 wt. % to about 0 wt. % of fiber materials, from about 5 wt. % to about 0 wt. % of fabric materials, from about 50 wt. % to about 25 wt. % polymer materials, and from about 10 wt. % to about 0 wt. % of metal materials. The waste pharmaceutical material or waste pharmaceutical material may also include from about 25 wt. % to about 5 wt. % of binding agents, from about 25 wt. % to about 5 wt. % of conventional fuels, and from about 5 wt. % to about 0 wt. % of ash materials. The makeup of the source pharmaceutical material may sum to an amount greater than 100 wt. %, making the component makeup relative instead of absolute. However, based on a given relative component makeup, the absolute component makeup may be determined. The augmenting materials are added to the source pharmaceutical material to adjust the makeup of the materials to better formulate the materials for use as a fuel or a landfill material.

In certain embodiments, the waste pharmaceutical material or waste pharmaceutical material includes from about 1 wt. % to about 10 wt. % of metal materials. In other embodiments, the waste pharmaceutical material or waste pharmaceutical material includes from about 1 wt. % to about 7.5 wt. % of metal materials. In other embodiments, the source pharmaceutical material includes from about 1 wt. % to about 5 wt. % of metal materials. In other embodiments, the waste pharmaceutical material or waste pharmaceutical material includes from about 1 wt. % to about 2.5 wt. % of metal materials.

In these formulations, the weight percentages are not confined to add up to 100%, but are relative amounts on a weight basis of the final composition.

To determine the actual percentage in final composition, all of the weight percentages would be added up to give the overall formulation weight, then simple percentages can be determined.

It should be recognized that these ranges are simply a set of component break downs and any other component make up can be used provided that if the composition is to be shaped, there is sufficient polymer material in the material to allow the compressed material to hold its shape under normal handling condition. In certain embodiments, the shaping can be performed with added heat, pressure, irradiation (e.g., electromagnetic radiation, acoustic radiation, ultrasonic radiation, etc.), chemical additives and/or chemical treatments, etc., to increase shape integrity and improve crush strength of the shaped material.

### Pre-Treatments

In certain embodiments, some or all of the input material or a material to be included in the input material is pre-treated to augment, change or remove components of a source pharmaceutical material. Such pre-treatments can include quality control testing, heating to remove volatile components, washing to remove water soluble components, solvent washing or extraction to remove solvent extractible components, pre-screening to remove materials having a certain size or construction for separate processing, partial pyrolysis to alter properties of the source material, drying to remove water, crushing of large objects into smaller objects for subsequent processing, any other pretreatment designed to condition a particular source material for use as a component in the input material used to produce the burnable fuels of this invention and any combination of these pre-treatments. Such pre-treating or pre-processing includes those set forth above. The pre-treatment may also be devices to added desired other materials such as binding agents, fuels, liquids, oxides, etc. to augment the composition of the source pharmaceutical material so that the augmented source pharmaceutical material has desired properties such as augmented fuel valve, augmented ash content, augmented properties to insure that the unused pharmaceuticals including over-the-counter (OTC) pharmaceuticals, prescription pharmaceuticals and controlled pharmaceuticals may not be readily extracted and/or otherwise used if the material is designed for landfilling.

### Disinfecting Pre-Treatment

In certain embodiments and for certain materials, some or all of the input material or materials that will ultimately be included in the input material is disinfected and/or partially or completely sterilized using any methodology known to render a disinfected material, substantially free of any harmful pathogens. In certain embodiments of this invention, disinfecting and/or partial or complete sterilization is performed via autoclave sterilization. The source used or waste material is placed in an autoclave at a temperature and pressure and for a time sufficient to render a disinfected material, free or substantially free of any harmful pathogens. The temperature is generally greater than at least 121° C., at a pressure of at least 15 psig and for a time of at least 30 minutes. In certain embodiments, the temperature is between about 121° C. and about 150° C., the pressure is between about 15 psig and about 50 psig and for a time between about 30 minutes and 60 minutes. In certain embodiments, the temperature is between about 121° C. and about 125° C., the pressure is between about 15 psig and about 25 psig and for a time between about 30 minutes and 60 minutes. In certain embodiments, the temperature is between about 121° C. and about 123° C., the pressure is between about 15 psig and about 20 psig and for a time between about 30 minutes and 40 minutes. Although specific embodiments have been set forth on temperature, pressure and time, higher temperatures and/or pressures can be used as well as shorter or longer times depending on a desired outcome or property of the disinfected material.

### Particle Distribution

The used or waste material, regardless of its makeup, is sized or sized and partially or completely homogenized or otherwise processed to reduce the particle size of the material and to form a particulate material having a certain particle size distribution and a certain degree of homogeny. The exact particle size distribution depends on the nature of the sizing or sizing and partially or completely homogenizing equipment used and on the screens or other size exclusion means used to control the particle size of the exiting particulate material and end use needs. The distribution of the present invention includes particles having a smallest dimension of between about 0.1 μm and about 1000 mm. In certain embodiments, the particles have a smallest dimension of between about 1 μm and about 500 mm. In certain embodiments, the particles have a smallest dimension between about 10 μm and about 500 mm. In other embodiments, the particles have a smallest dimension between about 100 μm and about 500 mm. In other embodiments, the particles have a smallest dimension between about 1 mm and about 500 mm. In other embodiments, the particles have a smallest dimension between about 1 mm and about 250 mm. In other embodiments, the particles have a smallest dimension between about 1 mm and about 100 mm. In other embodiments, the particles have a smallest dimension between about 1 mm and about 50 mm. In other embodiments, the particles have a smallest dimension between about 10 mm and about 50 mm. The smallest dimension means that the particles are capable of passing through a screen of a desired screen size. The screen size range between openings of about 12.7 mm to about 50.8 mm. In other embodiments, the screen opening ranges between about 19.05 mm and about 44.45 mm. In other embodiments, the screen opening ranges between about 19.05 and about 38.1 mm.

The term partially homogenized in the context of the present invention means that the particulate material, although being composed of many different material components, has been mixed sufficiently that the bulk composition of components is within about 30% the same throughout the entire particulate material. In certain, embodiments, the partial homogeneity is within 20% or lower. The term completely homogenized in the context of the present invention means that the particulate material, although being composed of many different material components, has been mixed sufficiently that the bulk composition of components is within about 10% the same throughout the entire particulate material. In certain, embodiments, the partial homogeneity is within 5%.

### Compressed Shapes

Optionally, the particulate material from the sizing process is then pressed, extruded or similarly processed into a shape to increase the bulk density of the material. The shape can be any shape including a cylindrical shape, a cubical shape, a rectangular solid shape, a spherical shape, an ellipsoidal shape, a tablet shape or any other compact 3D shape. The dimension of these shapes can range between about 0.5 cm and about 20 cm. In certain embodiments, the shape is substantially elongate shape having a diameter less than or equal to its length. The shape can be of a cylindrical type having sharp cut ends or rounded ends depending on the method used to make the elongate shape. Generally, the elongate shapes have a diameter between about 5 mm and about 20 mm and length of about 2 cm to about 10 cm. In certain embodiments, the elongate shape is cylindrical or substantially cylindrical. In other embodiments, the elongate shape has a diameter between about 10 mm and about 20 mm and a length between 3 cm and about 5 cm. In other embodiments, the elongate shape has a diameter between about 10 mm and about 15 mm and a length between 3 cm and about 5 cm. However, the shapes can be larger or smaller depending on end use. In other embodiment, the shape can have a diameter between about 0.5 cm and 20 cm. In other embodiment, the shape can have a diameter between about 0.5 cm and 20 cm and a length between about 0.5 cm and about 20 cm. In other embodiment, the shape can have a length, a width and a height between about 0.5 cm and 20 cm.

### Detailed Description of the Drawings

### Collection Apparatuses

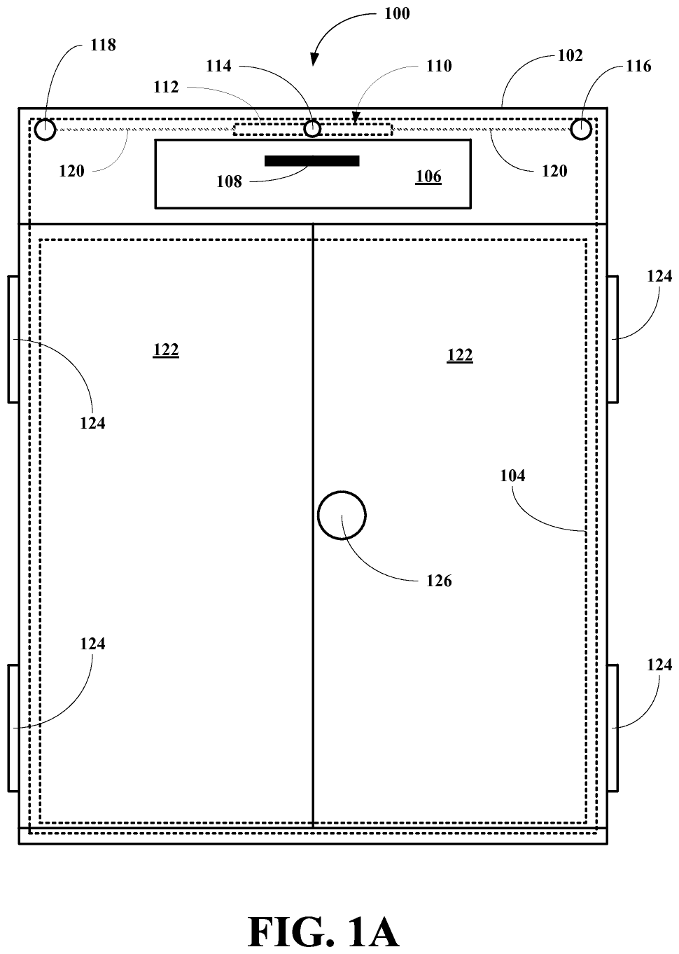

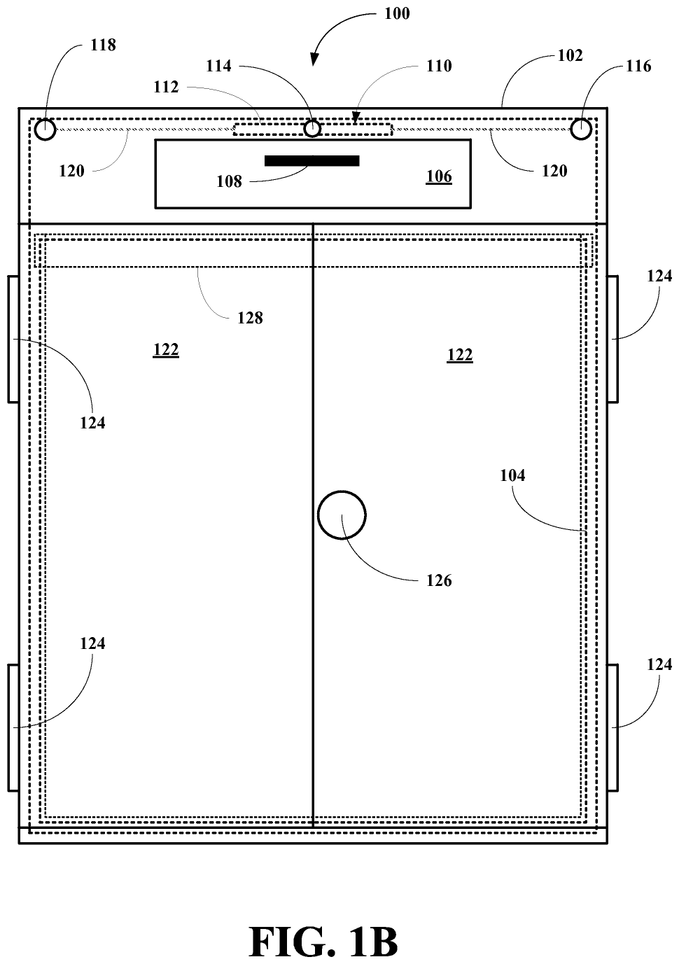

Referring now to FIG. 1A, an embodiment of a collection apparatus, generally 100, is shown to include an outer container 102 and an inner container 104. The outer container 102 includes a unidirectional openable member 106 having a handle 108. The outer container 102 also includes a monitoring system 110 including a processing unit 112, a camera 114, a speaker 116 and an LED display 118, where the processing unit 112 is in communication with the camera 114, the speaker 116, and the LED display 118 by communication pathways 120. The communication pathways 120 may be wired or wireless. The outer container 102 also includes two doors 122 mounted on the outer container 102 by hinges 124 and a lock 126 to securely lock the doors. The monitoring system 110 is designed to monitor use of the apparatus 100 and to reduce or prevent removing or tampering with the contents deposited in the inner container 104.

Referring now to FIG. 1B, another embodiment of a collection apparatus 100 of FIG. 1A is shown to include the outer container 102 and the inner container 104. The outer container 102 includes a unidirectional openable member 106 having a handle 108. The outer container 102 also includes a monitoring system 110 including a processing unit 112, a camera 114, a speaker 116 and an LED display 118, where the processing unit 112 is in communication with the camera 114, the speaker 116, and the LED display 118 by communication pathways 120. The communication pathways 120 may be wired or wireless. The outer container 102 also includes two doors 122 mounted on the outer container 102 by hinges 124 and a lock 126 to securely lock the doors. The inner container 104 includes a liner 128. The monitoring system 110 is designed to monitor use of the apparatus 100 and to insure against tampering of the contents deposited in the liner 128 of the inner container 104.

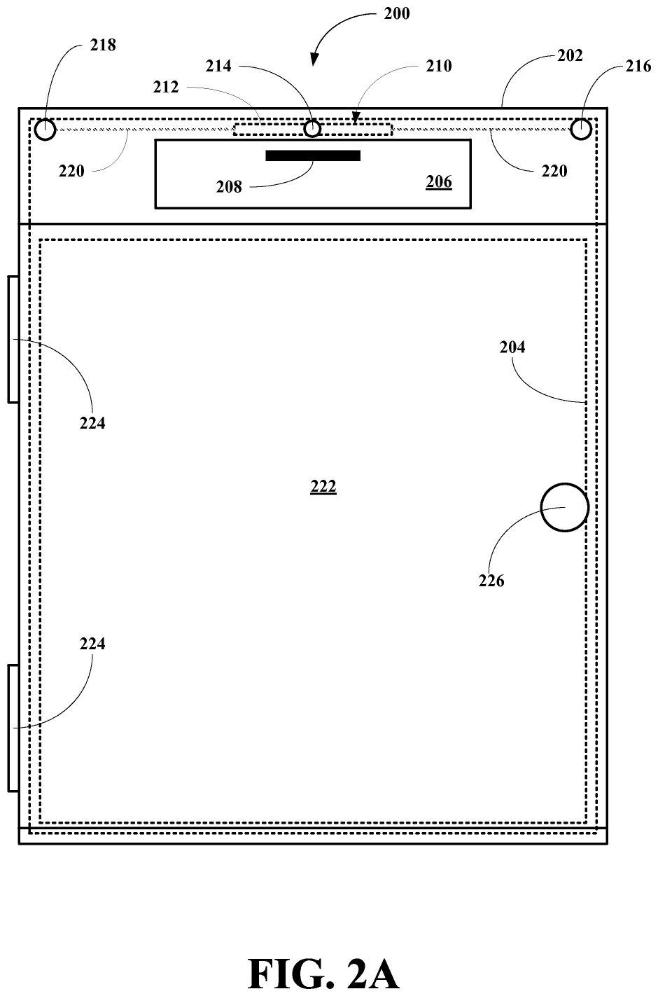

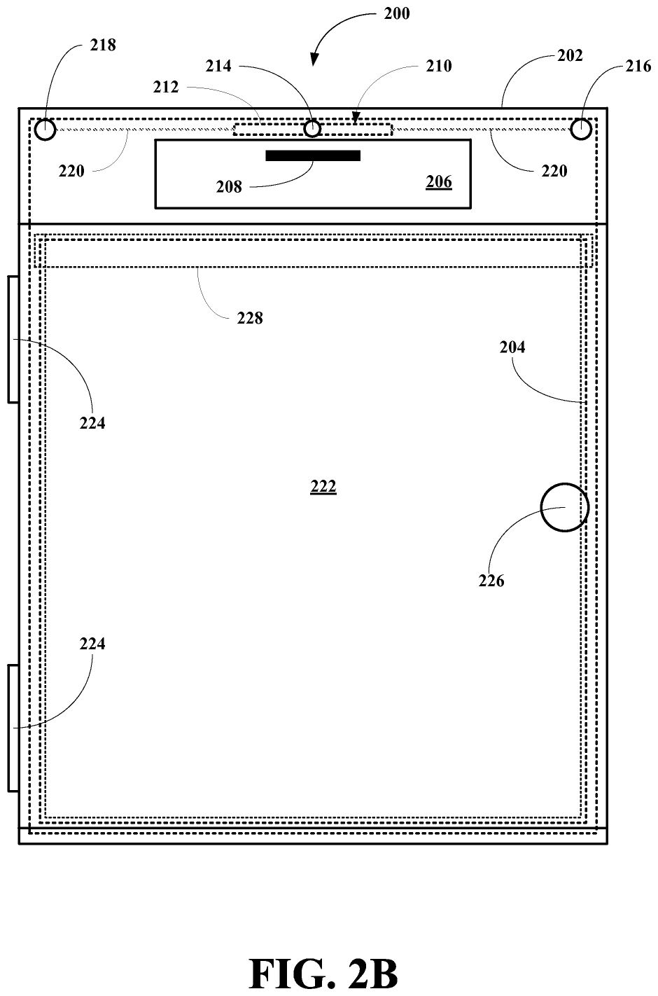

Referring now to FIG. 2A, another embodiment of a collection apparatus, generally 200, is shown to include an outer container 202 and an inner container 204. The outer container 202 includes a unidirectional openable member 206 having a handle 208. The outer container 202 also includes a monitoring system 210 including a processing unit 212, a camera 214, a speaker 216 and an LED display 218, where the processing unit 212 is in communication with the camera 214, the speaker 216, and the LED display 218 by communication pathways 220. The communication pathways 220 may be wired or wireless. The outer container 202 also includes door 222 mounted on the outer container 202 by hinges 224 and a lock 226 to securely lock the door. The monitoring system 210 is designed to monitor use of the apparatus 200 and to insure against tampering of the contents deposited in the inner container 204.

Referring now to FIG. 2B, another embodiment of a collection apparatus of FIG. 2A is shown to include the outer container 202 and the inner container 204. The outer container 202 includes a unidirectional openable member 206 having a handle 208. The outer container 202 also includes a monitoring system 210 including a processing unit 212, a camera 214, a speaker 216 and an LED display 218, where the processing unit 212 is in communication with the camera 214, the speaker 216, and the LED display 218 by communication pathways 220. The communication pathways 220 may be wired or wireless. The outer container 202 also includes a door 222 mounted on the outer container 202 by hinges 224 and a lock 226 to securely lock the door. The inner container 204 includes a liner 228. The monitoring system 210 is designed to monitor use of the apparatus 200 and to insure against tampering of the contents deposited in the liner 228 of the inner container 204.

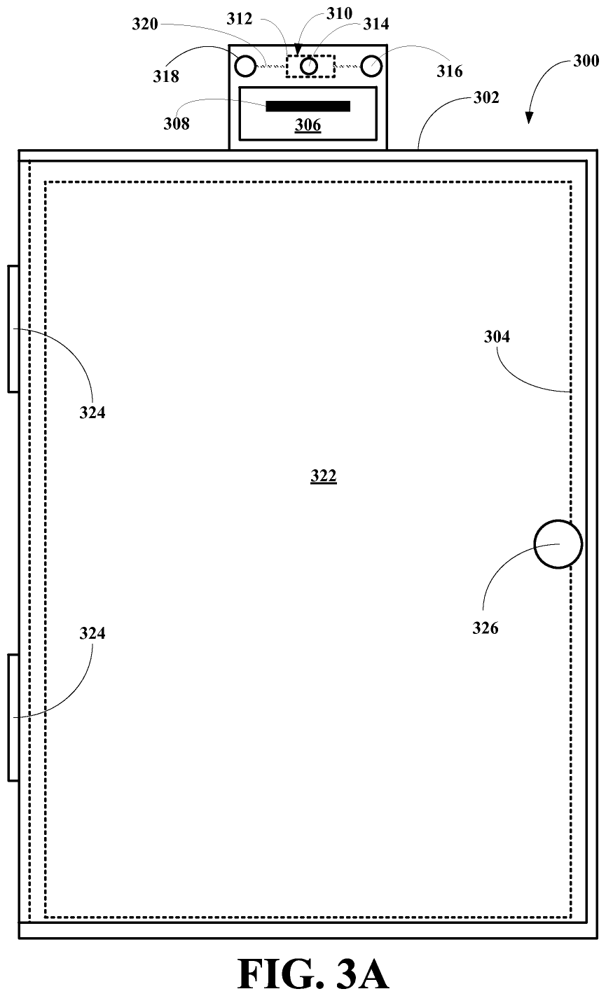

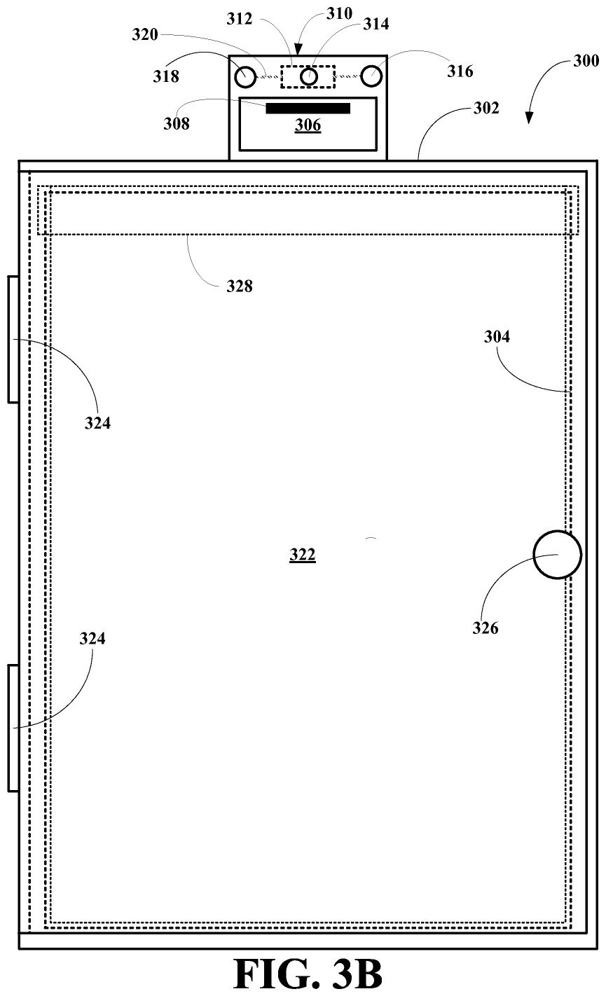

Referring now to FIG. 3A, another embodiment of a collection apparatus, generally 300, is shown to include an outer container 302 and an inner container 304. The outer container 302 includes a unidirectional openable member 306 having a handle 308. The outer container 302 also includes a monitoring system 310 including a processing unit 312, a camera 314, a speaker 316 and an LED display 318, where the processing unit 312 is in communication with the camera 314, the speaker 316, and the LED display 318 by communication pathways 320. The communication pathways 320 may be wired or wireless. The outer container 302 also includes a door 322 mounted on the outer container 302 by hinges 324 and a lock 326 to securely lock the door. The monitoring system 310 is designed to monitor use of the apparatus 300 and to insure against tampering of the contents deposited in the inner container 304.

Referring now to FIG. 3B, another embodiment of a collection apparatus 300 of FIG. 3A is shown to include the outer container 302 and the inner container 304. The outer container 302 includes a unidirectional openable member 306 having a handle 308. The outer container 302 also includes a monitoring system 310 including a processing unit 312, a camera 314, a speaker 316 and an LED display 318, where the processing unit 312 is in communication with the camera 314, the speaker 316, and the LED display 318 by communication pathways 320. The communication pathways 320 may be wired or wireless. The outer container 202 also includes a door 322 mounted on the outer container 302 by hinges 324 and a lock 326 to securely lock the door. The inner container 304 includes a liner 328. The monitoring system 310 is designed to monitor use of the apparatus 300 and to insure against tampering of the contents deposited in the liner 328 of the inner container 304.

### Inner Container

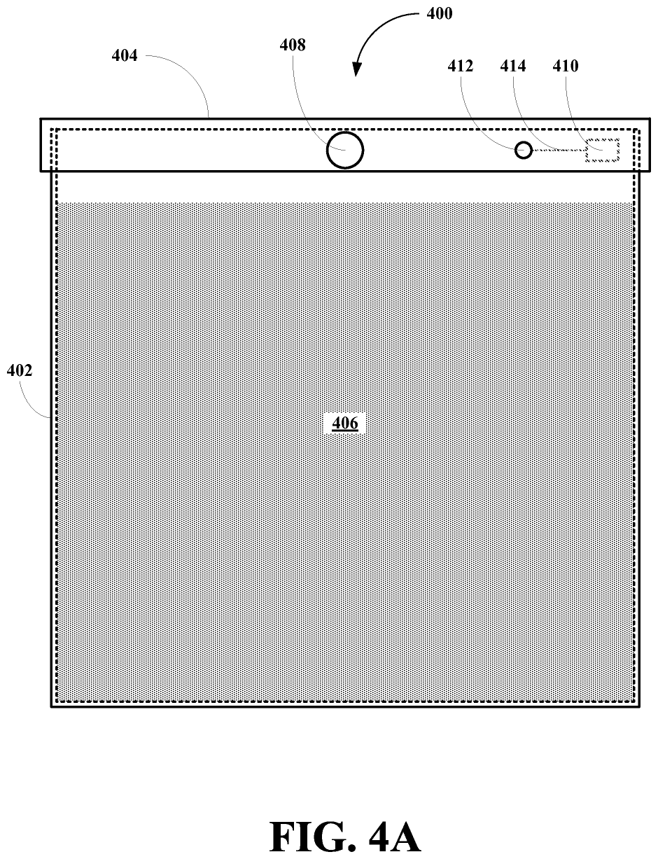

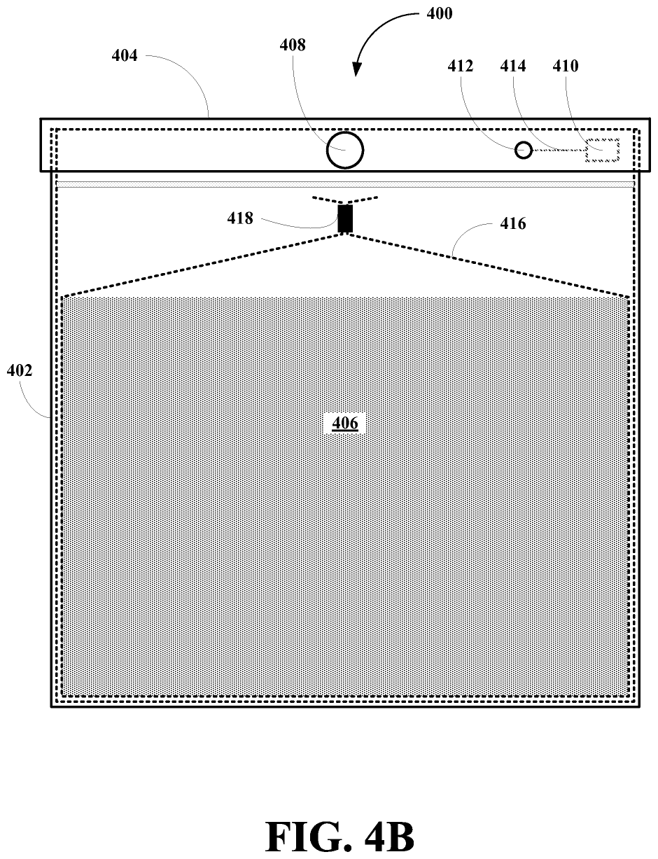

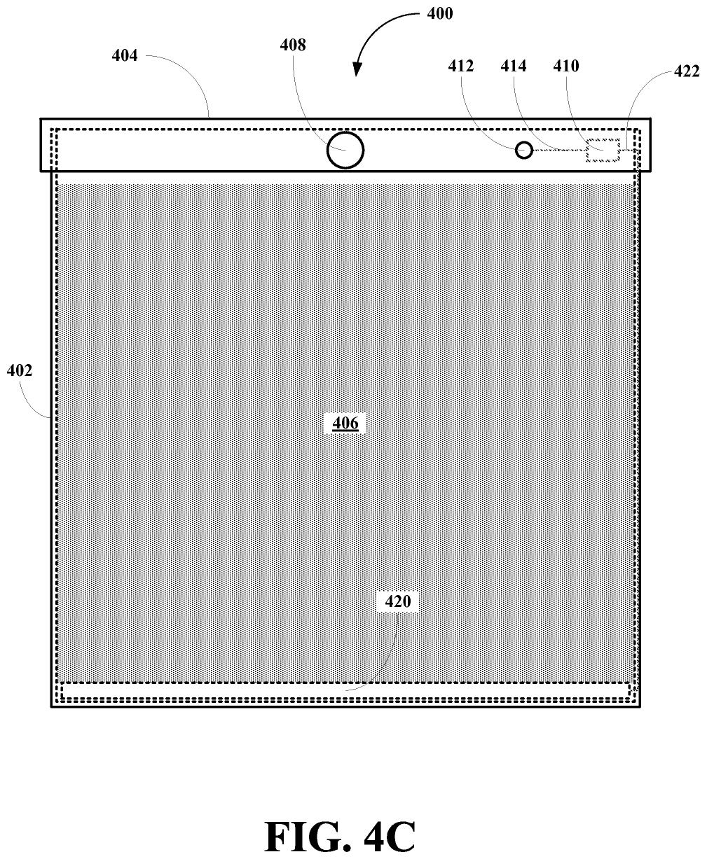

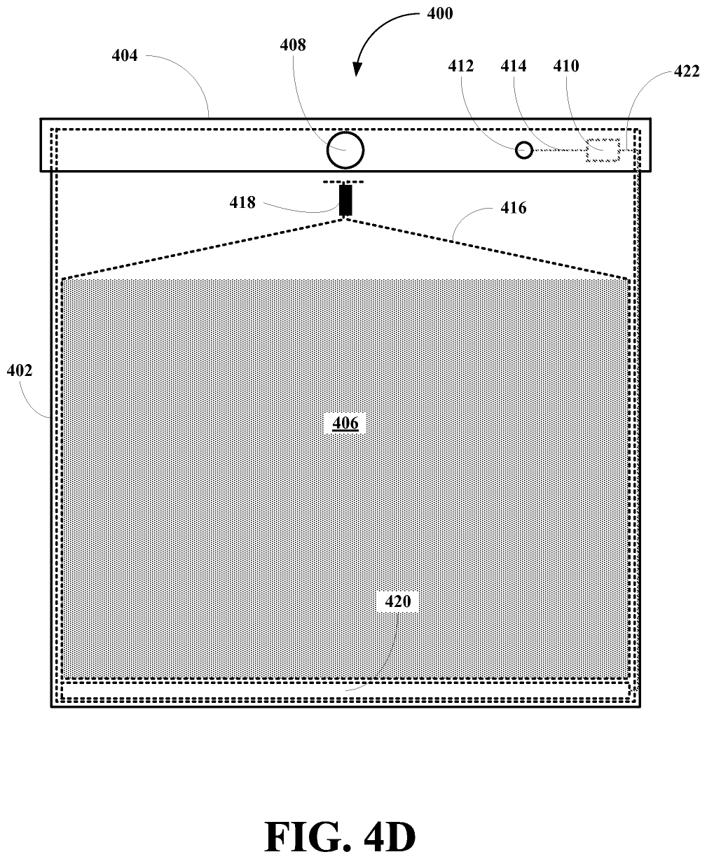

Referring now to FIG. 4A, an embodiment of an inner container, generally 400, is shown to include a body 402 and a lid 404. The body 402 is filled with a mixture of over-the-counter (OTC) pharmaceuticals, prescription pharmaceutical materials, controlled pharmaceutical materials, and//or other materials 406. The lid 404 includes a lock 408, a processing unit 410 and an LED display 412, where the processing unit 410 is connected to the LED display 412 via communication pathway 414.

Referring now to FIG. 4B, the inner container 400 in also shown to include a sealed liner 416, sealed by sealing member 418.

Referring now to FIG. 4C, an embodiment of an inner container, generally 400, is shown to include a body 402 and a lid 404. The body 402 is filled with a mixture of over-the-counter (OTC) pharmaceuticals, prescription pharmaceutical materials, controlled pharmaceutical materials, and//or other materials 406. The lid 404 includes a lock 408, a processing unit 410 and an LED display 412, where the processing unit 410 is connected to the LED display 412 via communication pathway 414.

Referring now to FIG. 4B, the inner container 400 in also shown to include a sealed liner 416, sealed by sealing member 418. The body 402 also includes a pressure sensor, pressure sensor pad, or an array of pressure sensors 420 in communication with the processing unit 410 via a communication pathway 422.

### Systems

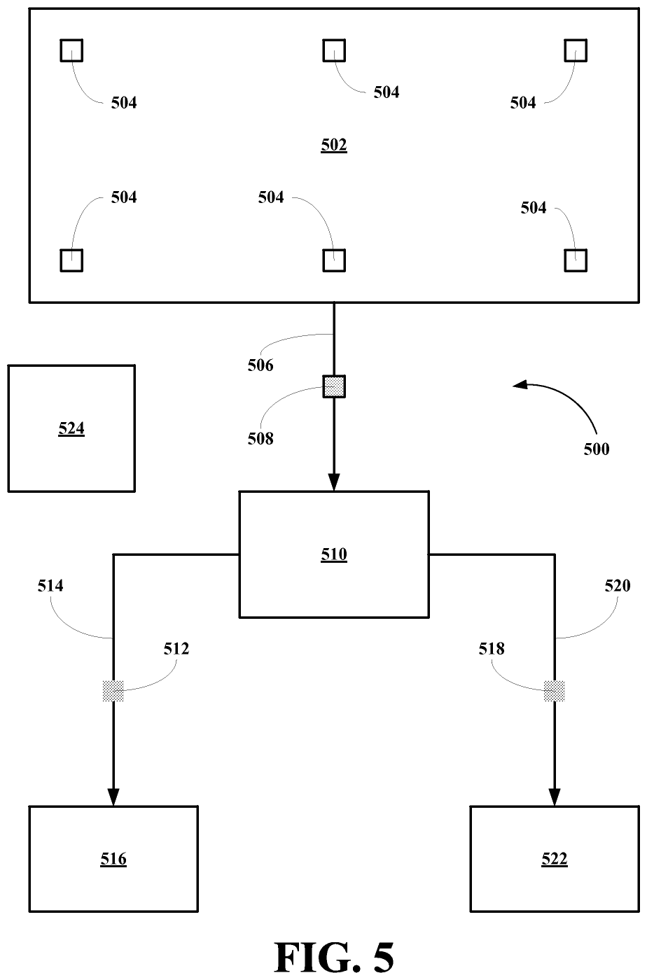

Referring now to FIG. 5, an embodiment of a collection system of this invention, generally 500, is shown to include a facility 502 that generates source waste pharmaceutical containing materials, where the facility 502 includes one or a plurality of collection apparatuses 504 distributed in the facility 502 for ease of deposition and collection of the source waste pharmaceutical containing materials. The collection apparatuses 504 include a lockable outer container and a transportable inner container as set forth in FIG. 1A-4B. The system 500 also includes a first transportation subsystem 506 comprising a common or contract carrier for shipping the inner containers 508 including the source waste pharmaceutical containing materials to a processing subsystem 510. In the processing subsystem 510, the inner containers 508 are collected and processed to form either a fuel material and/or a landfill material. The processing subsystem 510 may include disinfecting and/or sterilizing units such as autoclaves, microwave units, electromagnetic heating units, or mixtures and combinations thereof. The processing subsystem 510 may include also include a comminuting unit such as a shredding unit, milling unit, grinding unit, cryogrinding unit, pulverizing unit, shattering unit, any other unit that comminutes material or reduces its size, or mixtures and combinations thereof. The processing subsystem 510 may also include shaping units such as molding units, pelletizing units, extruding units, pressing units, other units that shape particulate materials into shapes, or mixtures and combinations thereof. The fuel material 512 may be in the form of particulate materials, shaped particulate materials, containerized particulate materials, containerized shaped particulate materials, or mixtures and combinations thereof. The fuel material 512 is transported via a second transportation subsystem 514 comprising a common or contract carrier to an incineration, power generation, and/or cement generation subsystem 516 for incinerating the source pharmaceutical material with or without power production and/or cement generation. The landfill material 518 particulate materials, shaped particulate materials, containerized particulate materials, containerized shaped particulate materials, or mixtures and combinations thereof. The landfill material 518 is transported via a third transportation subsystem 520 comprising a common or contract carrier to a landfill subsystem 522. The system 500 may also include a monitoring and/or tracking subsystem 524 for monitoring the deployed collection apparatuses 504 and for tracking the transportable inner containers 508. For monitoring, the collection apparatus 504 include a monitoring unit capable of monitoring deposits into the inner container and removing the inner container from the apparatus 504. For the tracking, the inner containers include a tracking unit capable of transmitting location information to the monitoring and/or tracking subsystem 524. For tracking the fuel material 512, the fuel material 512 is transported in a container including a tracking unit capable of transmitting location information to the monitoring and/or tracking subsystem 524. For tracking the landfill material 518, the landfill material 518 is transported in a container including a tracking unit capable of transmitting location information to the monitoring and/or tracking subsystem 524. The tracking subsystem 524 communicates with the deployed collection apparatuses 504, inner containers 508, the containers containing the fuel material 512 and the container containing the landfill material 518. For additional details on the system, the reader is directed to U.S. Pat. Nos. 8,100,989; 8,163,045; and 8,268,073.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1.-23 (canceled)

24. A collection apparatus comprising
a. a first outer container, the first outer container having:
i. an exterior, wherein the exterior is not adjacent to the exterior of a second outer container,
ii. an interior,
iii. a first opening; and
iv. a second opening;
b. a door, the door mounted to the first outer container, the door positioned so as to allow access to the interior of the first outer container through the second opening;
c. a unidirectional depositing member, the unidirectional depositing member communicating between the exterior and the interior of the first outer container through the first opening in the first outer container, wherein the unidirectional depositing member comprises:
i. a scoop unidirectional depositing member, the scoop unidirectional depositing member including a scoop mounted within the first opening, the scoop sized so as to accept waste pharmaceutical containing materials to be deposited into the interior, the scoop rotatable about an axis; or
ii. the unidirectional depositing member consists of a slit through the exterior; and
d. an inner container, the inner container positioned within the interior of the first outer container.

25. The collection apparatus of claim 24 further, wherein the unidirectional depositing member is the scoop unidirectional depositing member and wherein the scoop includes a handle on an outer surface of the scoop.

26. The collection apparatus of claim 25, wherein the handle is adapted to be pulled by a user to insert waste pharmaceutical containing materials.

27. The collection apparatus of claim 26 further comprising at least one shaft, wherein the scoop is mounted on the at least one shaft, wherein the at least one shaft is coincident with the axis.

28. The collection apparatus of claim 27, wherein the at least one shaft is a plurality of shafts.

29. The collection apparatus of claim 24, wherein the unidirectional depositing member is a slit and the slit is horizontal.

30. The collection apparatus of claim 24, wherein the outer container is metallic.

31. The collection apparatus of claim 24, wherein the inner container is constructed of pulp material.

32. The collection apparatus of claim 24, wherein the collection apparatus has only one outer container and only one inner container.

33. The collection apparatus of claim 24 further comprising a lock, the lock positioned so as to secure the door to the first outer container.

34. A process comprising:
a. supplying a collection apparatus, the collection apparatus comprising
i. a first outer container, the first outer container having:
1. an exterior, wherein the exterior is not adjacent to the exterior of a second outer container,
2. an interior,
3. a first opening; and
4. a second opening;
ii. a door, the door mounted to the first outer container, the door positioned so as to allow access to the interior of the first outer container through the second opening;
iii. a unidirectional depositing member, the unidirectional depositing member communicating between the exterior and the interior of the first outer container through the first opening in the first outer container, wherein the unidirectional depositing member comprises:
1. a scoop unidirectional depositing member, the scoop unidirectional depositing member including a scoop mounted within the first opening, the scoop rotatable about an axis; or
2. the unidirectional depositing member consists of a slit through the exterior; and
iv. an inner container, the inner container positioned within the interior of the first outer container; and
b. receiving pharmaceutical containing materials into the interior through the unidirectional depositing member.

35. The process of claim 34 further comprising receiving the pharmaceutical containing materials into the inner container.

36. The process of claim 35 further comprising removing the inner container and disposing of the waste pharmaceutical containing material as fuel in cement facilities or incineration facilities.

37. The process of claim 34, wherein the inner container is constructed of pulp materials.

38. The process of claim 34, wherein the step of receiving the pharmaceutical containing materials comprise:
a. rotation of the scoop to an open position caused by movement of a handle, the handle coupled to the scoop;
b. receipt of the pharmaceutical containing materials within the scoop; and
c. rotation of the scoop to a closed position caused by movement of the handle.

39. The process of claim 34, wherein the step of receiving the pharmaceutical containing materials comprises receiving the pharmaceutical containing members through the slit.

40. The process of claim 39, wherein the slit is horizontal;

41. The process of claim 34, wherein the collection apparatus has only one outer container and only one inner container.

42. The process of claim 34, wherein the unidirectional depositing member is a plurality of slits extending radially from a central point located on the exterior surface.

43. The process of claim 34 further comprising removing the inner container from the outer container through the second opening.
